(19) United States
(12) Patent Application Publication
(10) Pub. No.: US 2026/0022071 A1
(43) Pub. Date: Jan. 22, 2026

(54) LIGHTWEIGHT CONCRETE COMPOSITIONS AND USES OF SAME

(71) Applicant: Brickworks Building Products PTY LTD, New South Wales (AU)

(72) Inventors: Lloyd James Gainey, New South Wales (AU); Althea Mai Neo Caballero, New South Wales (AU)

(21) Appl. No.: 19/108,956

(22) PCT Filed: Sep. 8, 2023
(86) PCT No.: PCT/AU2023/050868

§ 371 Date: Mar. 5, 2025

(30) Foreign Application Priority Data
Sep. 9, 2022 (AU) 2022902606

(51) Int. Cl. C04B 28/04; C04B 20/00; C04B 111/00; C04B 111/40

(52) U.S. Cl. CPC C04B 28/04; C04B 20/0096; C04B 2111/00198; C04B 2111/40

(57) ABSTRACT

Described herein are cementitious compositions for forming a lightweight concrete on curing, comprising a cementitious binder, a lightweight aggregate, a non-lightweight aggregate, dispersible fines of size <75 μm in an amount of from 15.0 to 30.0 vol % as measured without use of a dispersant, coarse particles of size >2.36 mm in an amount of ≤30 vol %, and, water, as well as methods of using same to prepare lightweight concretes and lightweight concrete blocks.

### TECHNICAL FIELD

The disclosure herein relates to compositions and materials suitable for use in building and construction. The disclosure also relates to processes for manufacturing such compositions and materials. More particularly, the disclosure herein relates to cementitious compositions having properties suitable for casting into blocks and the like and concrete materials including blocks formed therefrom.

### BACKGROUND OF INVENTION

Cementitious compositions or mixes for forming concrete generally comprise cementitious binder (such as Portland cement), aggregate (fine and coarse, such as sand, gravel and/or rocks) and water. By way of example, a nominal concrete mix may comprise 1 part cement, 2 parts sand, and 4 parts coarse aggregate (1:2:4), but ratios of 1:1.5:3 or 1:3:6 are also common. Cementitious compositions cure to form hardened concrete, during which time hydration reactions between water and the cementitious binder bonds the aggregate components together to form a solid material.

The strength of hardened concrete is determined by the nature of the aggregate and binder and the relative proportions of each in the mix (as well as any other additional components present). One way to quantify concrete strength is to measure its compressive strength or ability of concrete to withstand loads that affect/decrease its size. Compressive strength is often measured and reported in MPa at day 28 after casting. Standard masonry blocks usually have 28-day compressive strengths of between 10 and 20 MPa.

In addition to binder and water, aggregates or other materials optionally having pozzolanic or latent hydraulic properties are sometimes added to concrete compositions or substituted for Portland cement in concrete compositions to improve or augment the properties or cost of the concrete. These materials include coal fly ash, limestone, ground granulated blast furnace slag, and silica fume, and the properties they influence may include cure rate, heat of hydration, water requirement, and/or the chemical resistance and/or strength/flexural properties of the final concrete.

Coal ash is a by-product of the coal combustion process and is a known concrete additive or supplementary cementitious material. Coal ash is divided into types, one type being fly ash, which is the fine ash material created when pulverised coal is burned, and one type being bottom ash, which is a coarser ash product that forms at the bottom of a coal furnace. Although each type of coal ash (fly, bottom) has a general chemical makeup, the precise chemical composition of each individual ash sample is influenced to some degree by the type of coal being burned and the combustion conditions employed. For coal bottom ash, the main components include both amorphous and crystalline silicon dioxide (SiO₂), aluminium oxide (Al₂O₃), iron oxide (Fe₂O₃), and calcium oxide (CaO), but may also include other minerals such as oxides of potassium, magnesium, and/or titanium. The particle size distribution of bottom ash varies according to source, but is generally put through a screening process to regulate particle size such that it comprises particles ranging in size from less than 75 μm up to about 5 mm in diameter and having an average diameter typically in the range of 50 μm to 200 μm. Bottom ash, and coal bottom ash in particular, has been used to date in cementitious compositions predominantly as a structural fill, but may also be used as a substitute or replacement for fine aggregate, such as sand. Use of bottom ash is recognised to cause issues such as stiffening and reduced workability of the mix due to its tendency to absorb water, decreased concrete setting time, reduced concrete strength, and can cause loss of water due to absorption.

“Lightweight” concretes are also known, and may be achieved by adding air, foams, or lightweight aggregates such as expanded polymers to concrete compositions. The side effect of adding such aggregate materials is that lightweight concretes are less dense than standard concretes, being generally more porous and/or incorporating softer aggregate materials, and therefore have strengths generally reduced compared to standard concretes. In order to compensate for losses in compressive strength caused by lowering the concrete density, lightweight concrete blocks known in the art rely on an increased cement content in the concrete/cementitious mixture. The proportion of cement in commercial concrete mixes is a key parameter because cement is required to bind together the aggregate to give concrete its structure and therefore contributes to its compressive strength, but it is also typically the most expensive component of a concrete mix. Therefore, increasing the cement content of a concrete generally, but especially of a lightweight concrete, is not desirable from a commercial cost perspective. Furthermore, high cement content-lightweight concrete blocks known in the art and having compressive strengths approaching standard concrete blocks (up to 40 MPa) tend to have higher densities, such as densities falling within about 10-15% of that of a standard block, making them less “lightweight” and therefore less able to take advantage of lowered transport costs, increased manoeuvrability, and larger sized materials for an equivalent mass. Apart from increasing cement content, other approaches currently known in the art to produce strong lightweight concrete blocks in particular use in excess of 40-50 vol % of ash materials, but such mixes are dry and chalky and increase energy consumption and machine wear in standard block pressing machinery.

Improved cementitious compositions and concrete materials that address one or more of the above problems or at least provide a useful alternative are desirable. For example, it would be desirable to produce lightweight concrete materials having strengths approaching those of standard concrete materials at commercially viable costs. It would also be desirable for lightweight concrete materials to have flow properties that render them suitable for use with standard block pressing machinery.

In one aspect, the invention described herein solves the problem of reduced strength lightweight concrete without addition of more cement by providing a cementitious composition comprising a solid component having both lightweight and non-lightweight aggregate, dispersible fines of size <75 μm in an amount of from 15.0 to 30.0 vol %, ≤30 vol % of coarse particles of size >2.36 mm, and aggregate particles of size ≥75 μm having a particle size distribution and/or shape that reduces particle packing such that the cementitious composition forms a cured lightweight concrete that has a 28 day ambient density of at least 20% lower than an average particle density of the solid component. In combination, these features produce lightweight concretes without compromising strength.

A reference herein to a patent document or other matter which is given as prior art is not to be taken as an admission that the document or matter was known or that the information it contains was part of the common general knowledge as at the priority date of any of the claims.

### SUMMARY OF THE INVENTION

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

According to a first aspect of the present invention, there is provided a cementitious composition for forming a lightweight concrete on curing, comprising: a solid component comprising: a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; wherein particles in the aggregate component of size ≥75 μm have a particle size distribution and/or shape that reduces particle packing such that the cementitious composition forms a cured lightweight concrete having a 28 day ambient density of at least 20% lower than an average particle density of the solid component.

The following features may be used in conjunction with the first aspect above either alone or in any suitable combination. The cementitious composition may form a cured lightweight concrete block having a 28 day compressive strength of from 15 to 35 MPa. The cementitious composition may form a cured lightweight concrete having a density of from 1600 to 1800 kg/m³, such as from 1650 to 1750 kg/m³. The size may be a maximum volume equivalent sphere diameter. The size and particle size distribution may be measured by laser diffraction and/or wet sieve analysis, optionally with use of a dispersant. The solid component may comprise dispersible fines of size <75 μm in an amount of from 20.0 to 30.0 vol % as measured without use of a dispersant, such as from 22.0 to 30.0 vol %. The solid component may comprise coarse particles of size >2.36 mm in an amount of ≤25 vol %, such as from 15 to 25 vol %. The particle size distribution of particles in the solid component of size ≥75 μm may be measured with use of a dispersant, such as a medium chain polyphosphate. The shape may be roundness and/or sphericity, such as mean roundness and/or mean sphericity. The particle size distribution may comprise at least 25 vol % of particles of size ≥75 μm in each of at least three size bins selected from (A) 4.75-2.36 mm, 1.18-2.36 mm and 0.600-1.18 mm (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm. The aggregate component may comprise at least 50 vol %, optionally at least 60 vol %, further optionally at least 70 vol %, particles having a subround shape and/or high sphericity, such as a sphericity of ≥0.7. The shape may have a roundness of >0.5, and optionally also a sphericity of >0.5, and wherein the particle size distribution comprises at least 25 vol % of particles of size ≥75 μm in each of at least three size bins selected from (A) 4.75-2.36 mm, 1.18-2.36 mm and 0.600-1.18 mm (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm. The particle size distribution may comprise at least 35 vol % of particles of size ≥75 μm in each of at least two consecutive size bins selected from, in order, (A) 4.75-2.36 mm, 1.18-2.36 mm and 0.600-1.18 mm, (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm. The aggregate component may comprise at least 30 vol %, optionally at least 40 vol %, further optionally at least 50 vol %, particles having a subangular shape and/or low sphericity, such as a sphericity of ≤0.5. The shape may have a roundness of <0.5, and optionally also a sphericity of <0.5, and wherein the particle size distribution comprises at least 35 vol % of particles of size ≥75 μm in each of at least two consecutive size bins selected from, in order, (A) 4.75-2.36 mm, 1.18-2.36 mm and 0.600-1.18 mm, (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm. The 28 day ambient density may be from 20% to 35% lower than the average particle density of the solid component. The lightweight aggregate may have an average particle density of from 0.01 to 2.0 g/cm3. The lightweight aggregate may be selected from: coal ash, including unclassified coal ash and coal bottom ash, other bottom ash, including biomass bottom ash, expanded perlite, expanded clay, expanded glass, expanded vermiculite, scoria, and biomass, including woodchip. The lightweight aggregate may be present in the solid component in an amount of from 10 vol % to 55 vol %, such as from 30 to 50 vol %. The lightweight aggregate may be a lightweight mineral aggregate, such as coal bottom ash, unclassified coal ash, or a mixture thereof, optionally wherein the coal bottom ash is saturated surface dry. The non-lightweight aggregate may have an average particle density of from 2.30-2.65 g/cm³. The non-lightweight aggregate may be selected from a natural sand, a manufactured sand, and a crushed rock, or a mixture thereof. The non-lightweight aggregate may be present in the solid component in an amount of from 35 to 80 vol %, such as from 40 to 55 vol %. The solid component may comprise from 5-15 vol % of cementitious binder, optionally from 8 to 12 vol % cementitious binder, optionally wherein the cementitious binder is Portland cement. The cementitious binder may form 35-75% by volume of the dispersible fines. The composition may comprise from 2-8 wt % free water, optionally from 4-6 wt % free water. The 28 day ambient density may be measured after from 6 to 24 hrs of steam curing and subsequent exposure to temperatures of from 15 to 35° C. and from 10 to 100% humidity. The cementitious composition may be in the form of a dry or zero slump mix. The cementitious composition may be in the form of a wet or non-zero slump mix.

According to a second aspect of the present invention, there is provided a lightweight concrete, comprising: a solid component comprising: a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; wherein particles in the aggregate component of size ≥75 μm have a particle size distribution and/or shape that reduces particle packing such that the lightweight concrete has a 28 day ambient density of at least 20% lower than an average particle density of the solid component.

According to a third aspect of the present invention, there is provided a block of cured lightweight concrete, comprising: a solid component comprising: a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; wherein particles in the aggregate component of size ≥75 μm have a particle size distribution and/or shape that reduces particle packing such that the cured lightweight concrete has a 28 day ambient density of at least 20% lower than an average particle density of the solid component.

The following features may be used in conjunction with the second or third aspects above either alone or in any suitable combination: Size may be a maximum volume equivalent sphere diameter. Size and particle size distribution may be measured by laser diffraction and/or wet sieve analysis, optionally with use of a dispersant. The solid component may comprise dispersible fines of size <75 μm in an amount of from 20.0 to 30.0 vol % as measured without use of a dispersant, such as from 22.0 to 30.0 vol %. The solid component may comprise coarse particles of size >2.36 mm in an amount of ≤20 vol %, such as from 15 to 20 vol %. The particle size distribution of particles in the solid component of size ≥75 μm may be measured with use of a dispersant, such as a medium chain polyphosphate. The shape may be roundness and/or sphericity. The 28 day ambient density may be from 20% to 35% lower than the average particle density of the solid component. The lightweight aggregate may have an average particle density of from 0.01 to 2.0 g/cm3. The lightweight aggregate may be selected from: coal ash, including unclassified coal ash and coal bottom ash, other bottom ash, including biomass bottom ash, expanded perlite, expanded clay, expanded glass, expanded vermiculite, scoria, and biomass, including woodchip. The non-lightweight aggregate may be selected from a natural sand, a manufactured sand, and a crushed rock, or a mixture thereof. The lightweight concrete may have a density of between 1600 and 1800 kg/m3, optionally between 1650 and 1750 kg/cm³. The lightweight concrete may have a water content after curing of from 3-5 wt %. The block of lightweight concrete may have a 28-day compressive strength of from 15 to 35 MPa, optionally of from 20-30 MPa. The block of lightweight concrete may have a strength:weight ratio of from 1.5 to 2.0, or of greater than 1.6, as measured as the 28-day compressive strength in MPa divided by the total weight of the block in kg. The block of lightweight concrete may have a strength:cement ratio of from 1.5 to 2.2, or of greater than 1.7, as measured as the 28-day compressive strength in MPa divided by the total volume of the cement in m3. The block may have a three-dimensional shape, optionally in the form of a three-dimensional H-block.

According to a fourth aspect of the present invention, there is provided a method of preparing lightweight concrete, comprising: preparing a cementitious composition comprising: a solid component comprising: a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; and, curing the cementitious composition to form lightweight concrete; wherein particles in the aggregate component of size ≥75 μm have a particle size distribution and/or shape that reduces particle packing such that the lightweight concrete formed from the cementitious composition has a 28 day ambient density of at least 20% lower than an average particle density of the solid component.

According to a fifth aspect of the present invention, there is provided a method of preparing lightweight concrete, comprising preparing a cementitious composition according to the first aspect above; and curing the cementitious composition to form lightweight concrete.

According to a sixth aspect of the present invention, there is provided a method of preparing a lightweight concrete block, comprising preparing a cementitious composition comprising: a solid component comprising: a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; and, pressing the cementitious composition into a mould; and curing the cementitious composition to form a lightweight concrete block; wherein particles in the aggregate component of size ≥75 μm have a particle size distribution and/or shape that reduces particle packing such that the lightweight concrete formed from the cementitious composition has a 28 day ambient density of at least 20% lower than an average particle density of the solid component.

According to a seventh aspect of the present invention, there is provided a method of preparing a lightweight concrete block, comprising preparing a cementitious composition according to the first aspect above; pressing the cementitious composition into a block mould; and curing the cementitious composition to form lightweight concrete.

Curing in the methods of any of the fourth to seventh aspects above may comprise exposing the cementitious composition to air and water vapour at a temperature of between 4° and 100° C. for a period of time of from 6 to 24 hours.

According to an eighth aspect of the present invention, there is provided lightweight concrete prepared by curing a cementitious composition according to the first aspect above, such as prepared by steam curing.

### BRIEF DESCRIPTION OF DRAWINGS

Embodiments of the invention will herein be illustrated by way of example only with reference to the accompanying drawings in which:

FIG. 1 is a graph of the particle size grading for cementitious compositions according to certain embodiments of the present invention on a vol % basis as measured by laser diffraction or wet sieve analysis using a dispersant.

FIG. 2 shows particle size distributions for compositions according to certain embodiments of the present invention and comparative examples in specified size bins that span three particle size sub-ranges.

FIG. 3 is a column graph showing the strength:weight and strength:cement ratios calculated experimentally for lightweight concrete materials formed from cementitious compositions according to certain embodiments of the present invention.

FIG. 4 shows the difference in particle size distribution in the dispersed fines <0.075 mm vs the total fines <0.075 mm in Mixes 1-4 and two comparative compositions.

FIG. 5 shows representative PSDs for selected aggregates described herein as measured by laser diffraction or wet sieve analysis using a dispersant.

### DETAILED DESCRIPTION

Described herein is cementitious composition for forming lightweight concrete on curing, comprising a solid component comprising a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; wherein particles in the aggregate component of size ≥75 μm have a particle size distribution and/or shape that reduces particle packing such that the cementitious composition forms a cured lightweight concrete having a 28 day ambient density of at least 20% lower than an average particle density of the solid component.

The present inventors have discovered a cementitious composition with a dispersible fines content of 15-30 vol %, where the dispersible fines have particle sizes of <75 μm, cures to produce a lightweight concrete block with surprisingly greater compressive strength compared to an equivalent concrete containing less than 15 vol % of such dispersible fines. The present inventors hypothesise that the <75 μm particle size fraction, which may receive contributions from the lightweight aggregate material, non-lightweight aggregate material and/or the cementitious binder, advantageously assists in particle packing of the cementitious composition during curing, resulting in a better bonded concrete product having increased relative compressive strength. It is thought that the 15-30 vol % of dispersible fines may induce a sufficient particle packing advantage in the compositions herein to overcome any negative contribution to the overall strength of the concrete caused by incorporating a lightweight aggregate. In some embodiments, dispersible fines contents of 20-30 vol % are particularly advantageous in this regard.

Additionally, in contrast to previous efforts to strengthen lightweight concrete, inclusion of 15-30 vol % dispersible fines, and especially 20-30 vol % dispersible fines, surprisingly and advantageously allows for relatively lower amounts of cement to be included in the cementitious compositions described herein, which provides a commercial benefit in terms of the cost of the compositions and the final concrete products into which they are pressed. In some embodiments, lightweight compositions and concretes described herein require 30-50% lower cement content compared to equivalent lightweight compositions with less than 15-30 vol % dispersible fines to achieve the same compressive strengths. In doing so, the presently described compositions enable production of unexpectedly strong and commercially viable concrete materials.

It has further been found that the density of concretes produced from cementitious compositions described herein may advantageously utilise air voids between particles in the cured concrete to reduce concrete density. In combination with the other features of the compositions as described herein, by adjusting the particle size distribution and/or shape of particles of size ≥75 μm in the aggregate component, particle packing may be reduced such that the cementitious composition forms a cured lightweight concrete having a 28 day ambient density of at least 20% lower than an average particle density of the solid component. Lightweight and non-lightweight aggregates used herein have known particle shape characteristics that can be exploited to amplify the reduction in particle packing and facilitate incorporation of air voids between particles in the compositions and concretes produced from curing same. By considering the degree to which the known particle shape of aggregate materials contributes to particle packing efficiency, the particle size distribution for the aggregate component can be adjusted to enhance particle packing (i.e., to have greater variance in particle size) or to reduce particle packing (i.e., to have greater uniformity). In such a way, the present invention may take advantage of air voids formed between particles in the cured concrete to reduce the final concrete density. The compositions herein also comprise ≤30 vol % of coarse aggregate >2.36 mm in size, which assists in further reducing concrete density. Although reduction in coarse aggregate would usually cause a concomitant reduction in strength of a concrete, the compositions herein incorporating at least 15-30 vol % (and especially 20-30 vol %) of dispersible fines are surprisingly able to overcome this loss of strength. The cementitious compositions herein therefore unexpectedly produce concretes that are both lightweight and strong, and in particular, strong enough in some embodiments to meet civil construction compressive strength standards when pressed into blocks.

This result is particularly surprising in light of conventional mix design principles, which aim to minimise the concentration of fine particles <300 μm and particularly, dispersible fines (including clay/silt) having a diameter of <75 μm in a cementitious mixture. The reasons for this include the (a) fine particles can make a cementitious composition gluggy and reduce flowability, (b) fewer fine particles means less water demand in the concrete (which is beneficial because increased water content is known to be associated with lower strength in concretes), and (c) smaller particles tend to increase the surface area that cement needs to bond to, therefore increasing the amount of cement needed to bond to and hold together the concrete. The present inventors have discovered that these drawbacks are not experienced by the compositions and concretes described herein as a result of interplay between the dispersible fines, coarse particles, and the air-void system.

Production of cementitious compositions and concretes also requires consideration of the flow properties of the compositions, which on an industrial scale are usually pressed into moulds using machinery. In the case of semi-dry or “zero slump” mixes, increased energy use, increased costs and/or accelerated machinery wear and tear may be faced by manufacturers if the flow properties of the mix slow down mixing or make the addition of additives to change the rheology of the mix necessary. It is therefore a further surprising feature of the cementitious compositions described herein that, when being pressed into blocks, they have improved flow times into and through the block machine relative to mixes with less than 15 vol % or greater than 30 vol % of dispersible fines, >30 vol % of particle sizes >2.36 mm, and highly efficient particle packing such that the cementitious composition forms a cured lightweight concrete having a 28 day ambient density within 20% of the average particle density of the solid component. The present inventors believe that these three features, in combination with inclusion of a lightweight aggregate, surprisingly give the cementitious compositions herein improved flow properties in industrial block pressing machinery compared to traditional lightweight mixes, with improvements in each cycle time in certain embodiments of equal to or exceeding 3-12%. Such improvements offer a significant commercial advantage over time not only in terms of greater production capacity of the machinery, but also in machinery wear-and-tear cost per block.

In the discussion that follows, references and descriptions of components of the cementitious compositions will be understood to apply to those components when in the form of concrete and/or concrete blocks formed by curing the cementitious compositions described herein, unless the context clearly indicates otherwise.

Disclosed herein are cementitious compositions for forming concrete on curing, comprising a solid component comprising a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; wherein particles in the aggregate component of size ≥75 μm have a particle size distribution and/or shape that reduces particle packing such that the cementitious composition forms a cured lightweight concrete having a 28 day ambient density of at least 20% lower than an average particle density of the solid component. The cementitious compositions described herein suitably cure to form a hardened lightweight concrete. Accordingly, cementitious compositions, as well as lightweight concretes prepared by curing those cementitious compositions, as well as cured lightweight concrete blocks prepared from those cementitious compositions, are encompassed by the present invention.

Also disclosed herein is a cured lightweight concrete or a block of cured lightweight concrete comprising a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; wherein particles in the aggregate component of size ≥75 μm have a particle size distribution and/or shape that reduces particle packing such that the cured lightweight concrete has a 28 day ambient density of at least 20% lower than an average particle density of the solid component.

As used herein the term “cementitious binder” refers to materials that bond a concrete by undergoing a hydration reaction or the like in the presence of a sufficient quantity of water. Hydraulic cement, particularly Portland cement (both of which are herein referred to generally as “cement”), slag, silica fume, and geopolymer are examples of cementitious binders. In some embodiments, the preferred cementitious binder herein is Portland cement. In some embodiments, additional cementitious materials like classified coal fly ash may also be included in the compositions herein, generally in admixture with one or more other cementitious binder(s).

As used herein, the term “cementitious composition” refers to a composition that includes a cementitious binder, an aggregate component, and water, which together form a composition that cures to form hardened concrete. Optionally, cementitious compositions described herein may include other components, such as a filler or additive. Aggregates, additives and fillers include, but are not limited to, sand, clay, fly ash, air entrainment agents, colourants, and the like. For the avoidance of doubt, the term “cementitious composition” refers to a pre-cured mix that is able to form hardened concrete on curing.

As used herein, the term “solid component” includes cementitious binder and the aggregate component, and optionally filler(s) and/or additive(s) if included, but excludes free water.

“Free water” refers to water that is added to the solid component, rather than being encapsulated/absorbed into any one or more of the materials comprising the solid component. By way of example, a saturated surface dry coal ash may be provided and included as a solid component, whereas water added to a mixture of saturated surface dry coal ash, sand and cement may be considered free water.

As used herein and unless clearly indicated by context to the contrary, all volume and weight percentages refer to a solids only composition (i.e., excluding free water). A certain volume or weight of water may be added to the solid components of the composition for use, including for moulding.

As used herein, the term “concrete” refers generally to a hard material made by mixing a cementitious composition with sufficient water to cause the cementitious composition to cure or set.

The term “lightweight concrete” refers to a hardened concrete that has a density of less than 2100 kg/m³, such as between 1000 kg/m³ and 2100 kg/m³.

The term “aggregate” as used in the context of an “aggregate component” herein includes particulate or granular materials added to cementitious compositions to provide structure and/or strength to a cured concrete. Aggregate may include sand, ash, crushed rock and gravel.

As used herein, the term “lightweight aggregate” refers to a sub-category of aggregate that has an average particle density of ≤2 g/cm³, such as from 0.05 to 2.0 g/cm³. The average particle density is the average dry, solid mass of particles of a material per unit volume (i.e., with no air spaces between the particles). As used herein, the term “lightweight mineral aggregate” refers to sub-category of lightweight aggregate that comprises one or more mineral components. In some embodiments, the mineral components include silica, silicates, and/or aluminosilicates. Non-limiting examples of lightweight mineral aggregates include unclassified coal fly ash and coal bottom ash, other bottom ash, such as biomass bottom ash, expanded perlite, expanded clay and expanded vermiculite. Examples of lightweight aggregates that are not lightweight mineral aggregates include biomass, such as wood chip.

As used herein, the term “non-lightweight aggregate” refers to a sub-category of aggregate that has an average particle density of >2 g/cm³, such as from 2.1 to 4.0 g/cm³. Non-limiting examples of non-lightweight aggregates include natural sand, manufactured sand, crushed rock, and the like.

As used herein, the term “coal ash” encompasses coal fly ash (classified and unclassified) and coal bottom ash. Coal fly ash refers to the light particulate coal combustion residue that is carried by flue gases and usually captured by filters or precipitators. As used herein, the terms “coal fly ash” and “classified coal fly ash” will be understood to be products that are screened to ensure ˜100% of particles are of size <75 μm and ≥75% of particles are of <45 μm in size. Classified fly ash is not an aggregate (lightweight or lightweight mineral aggregate) according to the disclosure herein.

As used herein, the term “unclassified coal fly ash” or related terms such as “unclassified ash” or “unclassified coal ash” or “run of station ash” refers to unscreened coal fly ash. Unclassified coal fly ash contains a higher proportion of larger particles than classified coal fly ash such that about 5-10 vol % of particles are of size 0.150-0.300 mm, about 14-20 vol % of particles are of size 0.150-0.075 mm, and about 70-80 vol % of particles are of size <75 μm.

As used herein, the term “vol %” of particles in the solid component (including cement and the aggregate component, such as bottom ash if present, sand if present, crushed rock if present, etc.) of a given cementitious composition refers to the volume of particles having a certain particle size, such from 150 μm to 75 μm, divided by the total volume of all particles in the solid component (having any particle diameter), multiplied by 100. Persons of skill in the art will be aware of methods by which volume may be measured, including by water displacement testing.

Particles of a specified size as described herein may be measured using any suitable particle size measurement method known in the art. However, for the avoidance of doubt, all particle sizes referred to herein have been measured using wet sieve analysis according to Australian Standard AS 1141.3.2:2021 Methods for sampling and testing aggregates-Sampling, Method 3.2: Rock spalls and boulders dated 26 Nov. 2021, or by laser diffraction, or by a combination of these two techniques. It will be appreciated that wet sieve analysis is suitable for particles of all sizes described herein but is a less sensitive technique for smaller particles (<150 μm) than laser diffraction. On the other hand, laser diffraction is mainly suitable for measuring particles under 300 μm in size, particularly <150 μm, as particles larger than this are difficult to keep in suspension for measurement. Laser diffraction and wet sieve analysis samples may be prepared with or without the aid of a dispersant. However, it will be appreciated that for some particle size measurements described herein that specify “without use of a dispersant”, sample preparation for laser diffraction, wet sieve analysis, or any other suitable method of measuring particle size, will not include addition of a dispersant.

The term “dispersant” herein in relation to particle size testing refers to compounds added to particulate mixes to stabilise and separate/disperse fine particles, especially silt and clay particles of size <75 μm. Any suitable dispersant may be used in the methods described herein, with a non-limiting example of a suitable dispersant being the medium chain polyphosphate commercially sold by ICL Phosphate Specialty as Calgon®. Methods of using a dispersant to prepare a material for particle size distribution (PSD) analysis will be known to those of skill in the art.

In one embodiment, particles of size <300 μm are quantified using laser diffraction with use of a dispersant. Suitable laser diffraction instruments will be known to those of skill in the art, but may include a Mastersizer® 3000 manufactured by Malvern Panalytical. In this embodiment, particle size and hence the concentration in vol % of particles of a certain size is calculated using results from laser diffraction, which reports particle size distributions in maximum volume equivalent sphere diameters for any given material. Accordingly, size in one embodiment refers to maximum volume equivalent sphere diameters as measured using laser diffraction.

In one embodiment, the quantity of particles of a certain size is measured using wet sieve analysis. In one embodiment, the size of particles is measured using wet sieve analysis with use of a dispersant. In a further embodiment, the size of particles is measured using wet sieve analysis without use of a dispersant. In these embodiments, the vol % of particles of a certain size is calculated by rinsing a mixture of particles through a series of increasingly finer sieves with water, wherein the mass of dried material retained at each sieve is measured. Suitable sieves for use herein include Sieve 12/#200/0.075 mm; Sieve 11/#100/0.150 mm; Sieve 10/#50/0.300 mm; Sieve 9/#30/0.600 mm; Sieve 8/#16/1.18 mm; Sieve 7/#8/2.36 mm and Sieve 6/#4/4.75 mm, etc. The resulting mass-based particle size distribution can be used to calculate mass %, being the mass of a particular particle size fraction divided by the total mass of the sample being measured, and then converted to vol % by using the particle density of particles in each component/fraction. Where applicable, a saturated surface dry particle density is used in place of a dry particle density for components such as coal ash that have a propensity to absorb water. For the purposes of calculation, it is noted that some materials, such as coal bottom ash and unclassified coal ash, become denser as particle size becomes smaller. Accordingly, the density of such materials is adjusted according to particle size for the purposes of vol % calculations herein. Wet sieve analysis is preferred for materials that contain higher concentrations of fine material, such as silt or clay, that have a tendency to aggregate but that can be separated by water. In some embodiments, materials having approximately >10 wt % of silt and >3 wt % clay having particles of size <5 μm fall into this category. In some embodiments, bottom ash and unwashed natural sands fall into this category. It will be understood that sieve analysis categorises particles into particle size groups according to a threshold particle (sieve) size. Accordingly, there will be a distribution of different particle sizes captured by each sieve, the size distribution of which will be determined by the size of sieve and the coarser sieve that preceded it.

In some embodiments, dry sieve analysis may be used. Dry sieve analysis is preferred for materials that either inherently (due to their structure/composition) or due to treatment (such as washing) contain only small amounts of fine material, such as silt or clay, that have a tendency to aggregate and are difficult to separate using mechanical shaking. In some embodiments, crusher dust, rock dust, and washed manufactured or natural sands having approximately <10 wt % of silt and/or <3 wt % clay having particles of size <5 μm fall into this category.

As used herein, the term “dispersible fines” refers to particles of size <75 μm that are dispersible within a cementitious composition during standard processing conditions. In one embodiment, the standard processing conditions include processing batches of cementitious compositions using a pan mixer, a ribbon mixer or a planetary mixer, in some embodiments, in batches of mass 1-2 tonnes. Accordingly, in one embodiment, the term “dispersible fines” as used herein refers to particles of size <75 μm that are dispersible in a pan mixer, a ribbon mixer or a planetary mixer. In another embodiment, the term “dispersible fines” as used herein refers to particles of size <75 μm that are dispersible in a pan mixer, a ribbon mixer or a planetary mixer in a cementitious composition batch having a mass of from 0.5-3.0 tonnes. In a further embodiment, the term “dispersible fines” as used herein refers to particles of size <75 μm that are dispersible in a pan mixer, a ribbon mixer or a planetary mixer in a cementitious composition batch having a mass of from 0.5-3.0 tonnes and using a shear rate of <750 rpm. By way of further explanation, the present inventors have observed that some materials, such as manufactured sands, coal bottom ash, and natural sand comprise particles of size <75 μm that are “locked up” in larger agglomerates within these materials. These “locked up” particles are not dispersible or “freed” within a cementitious composition during typical mixing processes. To quantify the dispersible fines, wet sieve analysis without use of a dispersant may be used to approximate the degree to which particles <75 μm disperse in a cementitious composition upon mixing, such as under standard processing conditions, in one embodiment, including when processing batches of cementitious compositions using a pan mixer, a ribbon mixer or a planetary mixer, in some embodiments, in batches of mass 1-2 tonnes. In this way, references herein to “dispersible fines” may refer to particles of <75 μm as measured using wet sieve analysis without use of a dispersant. In one embodiment, use of a high shear mixer is not a standard processing condition. In one embodiment, the term “dispersible fines” as used herein excludes particles of size <75 μm that are dispersible in a high shear mixer. A high shear mixer may use shear speeds of 750 rpm or greater.

By contrast, the term “total fines” refers to all particles of size <75 μm that are present in a given material or composition, whether dispersible or as part of agglomerates. Total fines may be quantified using wet sieve or laser diffraction techniques (or other suitable techniques known in the art) but with use of a dispersant prior to or during measurement to break down any agglomerates and release all fine particles in the material for measurement.

As used herein, the term “coarse particles” refers to particles of size >2.36 mm. In some embodiments, coarse particles exclude fibrous materials. In one embodiment, fibrous materials are those having an aspect ratio (ratio of length to diameter) of greater than 20, or greater than 30, or greater than 40, or greater than 50, or greater than 60, or greater than 75, or greater than 100, or greater than 150. In one embodiment, the coarse particles exclude steel fibres.

It should be understood that any numerical range recited herein is intended to include all sub-ranges subsumed therein. For example, a range of “from x to y” or “between x and y” is intended to include all sub-ranges between x and y and also range end points x and y. In one embodiment, the solid component of cementitious compositions described herein comprises particles having particle sizes of from 0.150-0.300 mm. This may be understood as encompassing particles having a particle size of 150 μm and 300 μm as well as all sizes in between, such as 151 μm, 152 μm, 153 μm, . . . , 297 μm, 298 μm and 299 μm, as well as all sub ranges in between, such as between 150 μm and 200 μm, and between 225 μm and 300 μm, and between 175 μm and 250 μm, etc. The term “less than z” or “<z” will be understood to encompass all values and sub ranges below, but not including, value z. All numbers or expressions referring to quantities used in the specification and claims are to be understood as modified in all instances by the term “about”. In some embodiments, “about” may mean within ±1%, or within ±2%, or within ±3%, or within ±4%, or within ±5%, or within ±10%.

As described herein, the solid component of cementitious compositions and/or concrete cured therefrom as described herein comprises dispersible fines of size <75 μm in an amount of from 15.0 to 30.0 vol % as measured without use of a dispersant. In one embodiment, the dispersible fines are quantified using wet sieve analysis without prior treatment with a dispersant. The solid component of the cementitious materials described herein may comprise from 15 vol % to 30 vol % dispersible fines, or from 15 to 25 vol %, or from 16 to 25 vol %, or from 17 to 25 vol %, or from 18 to 26 vol %, or from 19 to 26 vol %, or from 21 to 26 vol %, or from 21 to 28 vol %, or from 20 to 26 vol %, or from 24 to 28 vol %, or from 20 to 30 vol %, or from 26 to 30 vol %, or from 20.5 to 30 vol %, or from 21 to 30 vol %, or from 22 to 30 vol %, or from 23 to 30 vol %, or about 15.0, 16.0, 17.0, 18.0, 19.0, 20.0, 20.5, 21.0, 21.5, 22.0, 22.5, 23.0, 23.5, 24.0, 24.5, 25.0, 26., 27.0, 28.0, 29.0 or 30.0 vol % dispersible fines. For the avoidance of doubt, particles having a particle size of <75 μm include those having particle sizes ranging from 74.9 μm to 0.01 μm, optionally 1 nm. Typically, this fraction will comprise cement particles and fine particles from aggregate including sands, crushed rocks and/or coal ash, if present. A table of non-limiting examples of the proportion of dispersible fines (as a percent of total fines) present in some aggregate materials described herein is given in Table 1 below, and can be calculated for any given material by determining a concentration of fines from wet sieve analysis without use of a dispersant and dividing it by a total fines concentration (e.g., by using a dispersant in combination with wet sieve or laser diffraction):

TABLE 1
Approximate vol % of fines that are dispersible
in selected aggregate materials

| | Approximate vol % of fines |
|---|---|
| Material | that are dispersible |
| Manufactured Sand | 40-60 |
| Coal Bottom Ash | 20-40 |
| Unclassified Coal Ash | 100 |
| Natural Sand | 10-15 |
| Cement | 100 |

Persons of skill in the art will understand that a cementitious composition comprising from 15 to 30 vol % dispersible fines may be produced by combining cement and a non-lightweight and lightweight aggregate having known particle size distributions and known dispersible fines in appropriate proportions, such as in the proportions described herein. It is therefore envisaged that the precise contribution or chemical nature of contributors to the fraction of particles having particle sizes of <75 μm is not particularly limited. However, in one embodiment, the cementitious binder may form approximately 35-75% by volume of the dispersible fines in the cementitious compositions herein, such as from about 35 to 50 vol %, or from about 35 to 60 vol %, or from about 40 to 45 vol %, or from about 40 to 75 vol %, or from about 40 to 65% by volume of the dispersible fines. Such proportions may advantageously ensure that sufficient cement is present in the composition to form a strong and structurally stable concrete on curing. In some embodiments, a ratio of vol % dispersible fines:vol % cement in the solid component is from 1.4:1 to 3:1, or from 2.0:1 to 2.8:1, or from 1.4:1 to 2.5:1, or from 1.4:1 to 2.6:1, or 1.4:1, 1.5:1, 1.75:1, 2.0:1, 2.2:1, 2.4:1, 2.6:1, 2.8:1, or 3.0:1. In one embodiment, unclassified coal ash may form approximately 30-45% by volume of the dispersible fines in the cementitious compositions herein, such as from about 30 to 40 vol %, or from about 35 to 45 vol % by volume of the dispersible fines. In another embodiment, coal bottom ash may form approximately 5-25% by volume of the dispersible fines in the cementitious compositions herein, such as from about 5 to 12 vol %, or from about 7 to 18 vol %, or from about 7 to 22 vol % by volume of the dispersible fines. In a further embodiment, coal bottom ash and/or unclassified ash may form approximately 15-55% by volume of the dispersible fines in the cementitious compositions herein, such as from about 15 to 30 vol %, or from about 25 to 50 vol % by volume of the dispersible fines.

In other embodiments, the cementitious binder may form approximately 25-50% by volume of the total fines in the cementitious compositions herein, such as from about 25 to 35 vol %, or from about 25 to 45 vol %, or from about 40 to 50 vol %, or from about 40 to 45% of the total fines. In some embodiments, a ratio of vol % total fines:cement vol % in the solid component is from 2.0:1 to 3.5:1, or from 2.0:1 to 2.5:1, or from 2.2:1 to 3.3:1, or from 2.8:1 to 3.5:1, or 2.0:1, 2.1:1, 2.2:1, 2.3:1, 2.5:1, 2.75:1, 3.0:1, 3.1:1, 3.2:1, 3.3:1, 3.4:1 or 3.5:1.

In one embodiment, the particle size distribution of the aggregate component comprises at least 25 vol % of particles of size ≥75 μm in each of at least three size bins selected from (A) 4.75-2.36 mm, 1.18-2.36 mm and 0.600-1.18 mm (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm. In other embodiments, the particle size distribution of the aggregate component comprises at least 25 vol % of particles of size ≥75 μm in three size bins, or four size bins, or five size bins. In one embodiment, at least two of the size bins are not consecutive. The term “size bins” in this context refers to a combination of three consecutive size fractions as determined using wet sieve analysis methods. A consecutive size bin refers to (A) and (B), or (A) and (B) and (C), or (C) and (D), etc., being size bins that are next closest in size fraction range. In such embodiments, the aggregate component may comprise at least 50 vol %, or at least 60 vol %, or at least 70 vol %, particles having a subround shape and/or a high sphericity. In one embodiment, the shape may have a roundness of >0.5, and optionally also a sphericity of >0.5, and the particle size distribution of the aggregate component may comprise at least 25 vol %, or from 25-35 vol %, of particles of size ≥75 μm in each of at least three size bins selected from (A) 4.75-2.36 mm, 1.18-2.36 mm and 0.600-1.18 mm (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm. In some embodiments, the particle size distribution of the aggregate component may comprise at least 25 vol %, or from 25-35 vol %, of particles of size ≥75 μm in three, or four, or five size bins. In other embodiments, the particle size distribution of the aggregate component may comprise at least 25 vol %, or from 25-35 vol %, of particles of size ≥75 μm in three, or four, or five non-consecutive size bins.

In another embodiment, the particle size distribution comprises at least 35 vol %, or at least 40 vol %, or from 35-50 vol %, or from 40-50 vol %, of particles of size ≥75 μm in each of at least two consecutive size bins selected from, in order, (A) 4.75-2.36 mm, 1.18-2.36 mm and 0.600-1.18 mm, (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm. In one embodiment, the aggregate component comprises at least 30 vol %, or at least 40 vol %, or at least 50 vol %, particles having a subangular shape. In another embodiment, the shape of particles in the aggregate component has a roundness of <0.5, and optionally also a sphericity of <0.5, and the particle size distribution comprises at least 35 vol %, or at least 40 vol %, or from 35-50 vol %, or from 40-50 vol %, of particles of size ≥75 μm in each of at least two consecutive size bins selected from, in order, (A) 4.75-2.36 mm, 1.18-2.36 mm and 0.600-1.18 mm, (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm.

The cementitious compositions herein comprise $30 vol % particles having particle sizes of >2.36 mm. In some embodiments, the cementitious compositions herein comprise from 0.1 to 30 vol % particles having particle sizes of from 2.36 mm to 7 mm, or from 2.36 mm to 10 mm. In one embodiment, the solid component comprises from 0.1 to 30 vol %, or 1 to 30 vol %, or 5 to 30 vol %, or 8 to 30 vol %, or 10 to 30 vol %, or 15 to 30 vol %, or 15 to 25 vol %, or 5 to 15 vol %, or 18 to 22 vol %, particles having a diameter of >2.36 mm, or of particles having a diameter of from 2.36 mm to 7 mm, or of particles having a diameter of from 2.36 mm to 10 mm. A reduced coarse aggregate load may assist in reducing the density of the composition and concrete cured therefrom.

Particles of size ≥75 μm in the aggregate component of the compositions herein have a particle size distribution and/or shape that reduces particle packing such that the cementitious composition forms a cured lightweight concrete having a 28 day ambient density of at least 20% lower than an average particle density of the solid component. The present inventors have discovered that intentionally targeting reduced particle packing in the compositions herein below what would be considered standard or optimal in the art assists in producing lightweight density concretes without the need for further lightweight materials to be added. It also surprisingly provides benefits to the flow characteristics of the compositions. Improved flow characteristics include less work required by mixing machinery to mix the composition, and the mixed composition moving more quickly through block making machinery. Without wishing to be bound by theory, this is thought to be due at least in part to particle packing inefficiencies in the compositions herein allowing more air into the mix.

The present inventors have found that by considering the PSD of the aggregate component and/or the shape of particles comprising the aggregate component, that a range of different compositions may be made with different raw materials. Accordingly, the precise PSD of the aggregate component of the compositions herein is not particularly limited, and nor do the compositions herein require a particularly limited particle shape distribution to achieve a cured lightweight concrete having a 28 day ambient density of at least 20% lower than the average particle density of the solid component. Rather, where materials comprising the aggregate component have at least sub-round and high sphericity particles, a broader PSD can be tolerated by the composition and still reduce particle packing to a level required to achieve a cured lightweight concrete having a 28 day ambient density of at least 20% lower than the average particle density of the solid component. This is because rounded and spherical particles tend to pack together with voids between particles at the round edges of the particles, even when particles of a broad range of sizes are used. Conversely, where materials comprising the aggregate component have sub-angular and low sphericity particles, a narrower PSD will generally be required to reduce particle packing to a level required to achieve a cured lightweight concrete having a 28 day ambient density of at least 20% lower than the average particle density of the solid component. This is because angular and elongated particles tend to pack together more tightly and with fewer voids, and therefore rely more heavily on the packing efficiency reduction caused by packing particles of similar sizes. Persons of skill in the art will recognise that particles, and relevantly aggregate particles, can be qualitatively classified into shapes based on their sphericity and roundness, a typical scale being found in Lea's Chemistry of Cement and Concrete (Hewlett, P., Liska, M. Eds.) 5th Edition (2019), Butterworth-Heinemann, UK, the content of which is incorporated herein by reference. In summary, for a given 2D projection of a particle, roundness refers to the average radius of corners and edges divided by the radius of a maximum inserted circle, and sphericity refers to the nominal diameter divided by the maximum intercept. Particles are categorised under this system as low or high sphericity, with low sphericity being ≤0.5 and high sphericity being ≥0.7, and as well rounded, rounded or sub rounded (roundness ≥0.7) or sub-angular, angular or very angular (roundness being ≤0.5). As used herein, roundness and/or sphericity may refer to a mean roundness and/or mean sphericity. In some embodiments, the aggregate component herein will comprise an increased relative proportion of subround particles (over subangular particles) to improve flow characteristics of the cementitious compositions. In some embodiments, the aggregate component herein will comprise an increased relative proportion of spherical particles (over non-spherical particles) to decrease particle packing density in the cementitious compositions. Persons of skill in the art will recognise that visual inspection of a sample of aggregate will allow the shapes of particles to be ascertained and the proportion of each shape quantified as a % of total particles. In some cases, a representative sample of an aggregate may be used to quantify the particle shape distribution of an entire sample of aggregate. In some cases, it is sufficient to identify a dominant or overall particle shape for a given material for the disclosure herein. By way of non-limiting example only, the typical particle shapes of a selected group of aggregate materials suitable for use in the compositions described herein are given in Table 2 below:

TABLE 2
Typical particle shapes for a selected group of aggregate materials

| Aggregate | | | | | |
|---|---|---|---|---|---|
| material class | Type | Composition | Particle shape | Sphericity | Source/Product |
| Coal ash | Bottom ash | Combustion | Subround | High | Tarong bottom ash |
| | | by-product | | | Eraring bottom ash |
| Sand | Manufactured | Granite | Subangular | Low | Bracalba granite |
| | sand | | | | man sand |
| | Manufactured | Greywacke | Subangular | Low | Holcim greywacke |
| | sand | | | | man sand |
| | Natural sand | Sandstone | Subround | High | Clutha |
| Coarse | Crushed rock | Granite | Subround | Medium | Bracalba 7 mm |
| aggregate | Crushed rock | Greywacke | Subangular | Low | Holcim 7 mm |

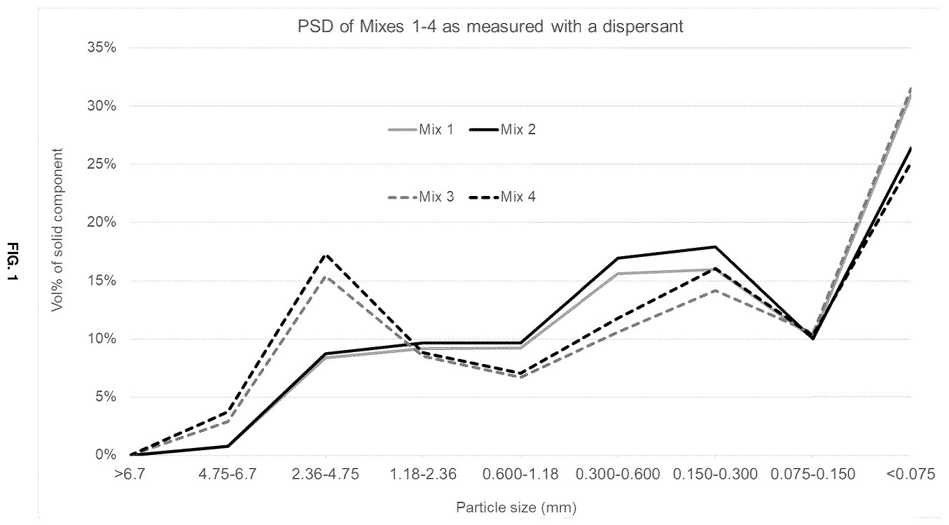

Examples of suitable PSDs for different proportions of particle shapes that reduce particle packing to a level required to achieve a cured lightweight concrete having a 28 day ambient density of at least 20% lower than the average particle density of the solid component are given in FIG. 1, discussed in further detail below. In some embodiments, the compositions herein may comprise an additive that increases slip in the mix, which may enable a relatively higher proportion of angular or subangular particles to be included in the composition (compared to a composition without the additive) and still reach the required concrete 28 day ambient density of at least 20% lower than the average particle density of the solid component. The slip additive may work to improve flow and/or increase particle packing for a given PSD by reducing friction between angular and subangular particles. Suitable commercial slip enhancing additives will be known to those of skill in the art, but include Mapei Vibromix A1 and Sika Block from Sika Australia.

In some embodiments, the solid component of the cementitious materials described herein comprises from 8 to 12 vol % particles having a particle size of between 150 μm and 75 μm, or from 8.0 to 10.0 vol %, or from 9.5 to 10.5 vol %, or from 10.0 to 11.0 vol %, or from 10.0 to 11.5 vol %, or about 9.5, 10.0, 10.5, or 11.0 vol % particles having a particle size of between 150 μm and 75 μm.

The compositions herein may include any suitable cementitious binder. In one embodiment, the cementitious binder is cement. In one embodiment, the cement is Portland cement. However, other suitable cementitious binders, such as lime, slag, silica fume, fly ash, geopolymer, magnesia based cement and calcium sulfoaluminate cement will be known to those of skill in the art. The cementitious compositions herein may contain any suitable amount of cementitious binder. In one embodiment, the cementitious compositions described herein may contain from 5-15 vol % of cementitious binder, or from 10-15 vol %, or from 8-12 vol %, or from 12-17 vol %, or from 15-20 vol % of cementitious binder, or may contain 9, 10, 11 or 12, 13, or 14 vol % cementitious binder. Commercial sources of cementitious binder will be known to those of skill in the art. A non-limiting example of a suitable cementitious binder is GP Cement from Southern Cross Cement, or High Early Strength Cement from ICL. In one embodiment, the cementitious binder comprises a classified fly ash. The classified fly ash may be present in the cementitious binder in an any suitable amount, or in an amount of up to 35 vol %, or from 0 to 30 vol %, or from 20 to 30 vol % of the cementitious binder, or in an amount of from 0-10 vol %, or from 0-5 vol %, or from 1-2 vol %, or from 5-10 vol %, or from 2-8 vol %, or from 3-7 vol % of the solid component. The fly ash may have a particle size distribution wherein silt particles <0.075 mm in diameter comprise about 100 vol % of the material, such as about 99.9 vol %, or 99.5 vol % of the material. Commercial sources of classified fly ash will be known to those of skill in the art. A non-limiting example of a suitable fly ash is the product Fly Ash from ICL (from Eraring Power Station, NSW, Australia).

The cementitious compositions herein comprise an aggregate component. The aggregate component comprises a lightweight mineral aggregate and a non-lightweight aggregate. As will be evident from the discussion below, the aggregate component is not particularly limited in composition, and suitable aggregate materials will be known to those of skill in the art. By way of non-limiting example only, suitable aggregate materials may include coal ash, other ash, sand (manufactured and/or natural), expanded perlite, expanded clay, expanded vermiculite, biomass, crushed rock or rock dust, etc. In some embodiments, the aggregate component comprises up to two lightweight mineral aggregates and up to two non-lightweight aggregates. The solid component of the cementitious compositions herein may contain any suitable amount of aggregate component. In one embodiment, the solid component contains from 85-95 vol %, or from 87 to 92 vol %, or from 88 to 91 vol % of the aggregate component.

The cementitious compositions herein comprise a lightweight aggregate. Any suitable lightweight aggregate material may be used, including, by way of non-limiting example, biomass-based materials such as woodchip or mineral-based materials such as ash, perlite, clay or vermiculite. In some embodiments, the lightweight aggregate is a lightweight mineral aggregate material comprising silica, silicates and/or aluminosilicates. In some embodiments, the lightweight aggregate material consists essentially of silica, silicates and/or aluminosilicates. In some embodiments, the lightweight aggregate material is selected from: coal ash, including unclassified coal fly ash and coal bottom ash, other bottom ash, including biomass bottom ash, expanded perlite, expanded clay, expanded glass, and expanded vermiculite, or a mixture of any two or more of these materials. In one embodiment, the lightweight aggregate material is a coal ash selected from unclassified coal fly ash and coal bottom ash. In some embodiments, the lightweight aggregate material is selected from expanded perlite, expanded clay, expanded glass, and expanded vermiculite. In some embodiments, the lightweight mineral aggregate material is selected from unclassified coal fly ash, coal bottom ash, expanded perlite, expanded clay and expanded vermiculite. In one embodiment, the lightweight mineral aggregate material consists of a mixture of unclassified coal fly ash and coal bottom ash. In some embodiments, the lightweight aggregate material has an average particle density of ≤2.0 g/cm³, or of ≤1.8 g/cm³, or of ≤1.6 g/cm³, or of ≤1.4 g/cm³, or of ≤1.2 g/cm³, or of ≤1.0 g/cm³, or of ≤0.5 g/cm³, or of ≤0.3 g/cm³, or of from 0.01 g/cm³ to 2.0 g/cm³, or of from 0.05 g/cm³ to 1.75 g/cm³. The cementitious compositions herein may contain any suitable amount of lightweight aggregate. In some embodiments, the lightweight aggregate is present in the solid component of the cementitious compositions and concretes cured therefrom in an amount of from 10 to 55 vol %, or of from 10 to 25 vol %, or of from 20 to 35 vol %, or of from 35 to 50 vol %, or of from 30 to 50 vol %, or from 38 to 50 vol %, or from 35 to 45 vol %, or from 30 to 45 vol %, or from 40 to 50 vol %, or 30, 35, 40, 45, 50 or 55 vol %.

The lightweight aggregate material described herein may comprise a bottom ash. In one embodiment, the bottom ash is coal bottom ash. Other bottom ashes suitable for use in the compositions herein will be known to a person of skill in the art and may include biomass bottom ash. The bottom ash may be a single bottom ash or may be a mixture of two or more bottom ashes. If a mixture of bottom ashes is used, the mixture may comprise two or more coal bottom ashes from different geographical sources or combustion plants, or may comprise two different types of bottom ash, such as a coal bottom ash and a biomass bottom ash. Commercial sources of bottom ashes, including coal bottom ashes, will be known to those of skill in the art. Such sources will generally be coal- or biomass-fired power stations or other industrial burners of coal or biomass, where the bottom ash is the granular, incombustible by-product collected at the bottom of the furnace burning the coal/biomass.

Bottom ash may be used in the solid component of the compositions herein in any suitable amount. Suitably, the bottom ash may be present in the solid component a concentration of from 20 to 50 vol %, or of from 20 to 30 vol %, or from 25 to 35 vol %, or from 25 to 40 vol %, or from 25 to 36 vol %, or from 30 to 50 vol %, or 20, 25, 30, 35, 40, 45 or 50 vol %. The bottom ash may have an average particle density of from 1.20-1.65 g/cm³, or of from 1.30-1.45 g/cm³, or of from 1.40-1.65 g/cm³, or of from 1.50-1.65 g/cm³.

In one embodiment, the lightweight aggregate comprises coal bottom ash. In embodiments where coal bottom ash is used in the compositions described herein, the coal bottom ash may be present in the solid component in any suitable amount. Suitably, the coal bottom ash may be present in the solid component at a concentration of from 20 to 55 vol %, or of from 20 to 30 vol %, or from 25 to 45 vol %, or from 30 to 50 vol %, or from 40 to 55 vol %, or 20, 25, 27.5, 30, 35, 40, 45, 50 or 55 vol %. The coal bottom ash may have an average particle density of from 1.50-1.65 g/cm³, or of from 1.50-1.60 g/cm³, or of from 1.55-1.65 g/cm³, or of from 1.6-1.65 g/cm³, or of about 1.58 g/cm³. The coal bottom ash used in the cementitious compositions and concretes cured therefrom as described herein may have any suitable PSD, but by way of non-limiting example only, a suitable PSD (calculated using wet sieve analysis with a dispersant, and converting mass to volume using the density of each fraction) is shown in Table 3:

TABLE 3
Example of suitable coal bottom ash particle
size distribution (wet sieve with dispersant)

| Particle size | Example | vol % in one |
|---|---|---|
| (mm) | vol % range | suitable embodiment |
| 6.70-9.50 | 0.0 | 0.0 |
| 4.75-6.70 | 0.5-1.5 | 0.9 |
| 2.36-4.75 | 2.0-6.0 | 3.8 |
| 1.18-2.36 | 3.0-8.0 | 5.4 |
| 0.60-1.18 | 3.0-8.0 | 5.2 |
| 0.30-0.60 | 12.0-18.0 | 14.5 |
| 0.15-0.30 | 26.0-34.0 | 30.3 |
| 0.075-0.15 | 16.0-22.0 | 19.1 |
| <0.075 | 18.0-24.0 | 20.8 |

The coal bottom ash may have a composition comprising crystalline quartz, mullite (an aluminium silicate material), cristobalite (a silicate mineral), kaolinite (a silicate clay material) and amorphous material and have a pH of about 6.9. Commercial sources of bottom ash will be known to those of skill in the art. A non-limiting example of a suitable bottom ash is the coal bottom ash available from Tarong Power Station in QLD, Australia and marketed as Bottom ash, but other bottom ashes, such as that available from Eraring Power Station, may also be suitable. Coal bottom ash generally comprises particles having subround shape and high sphericity (see Table 1).

In one embodiment, the lightweight aggregate comprises unclassified fly ash. The unclassified fly ash may be present in the solid component in any suitable amount. Suitably, the unclassified fly ash may be present in the solid component at a concentration of from 5 to 25 vol %, or of from 5 to 15 vol %, or from 9 to 13 vol %, or from 10 to 20 vol %, or from 15 to 25 vol %, or from 8 to 14 vol %, or 5, 7.5, 10, 11.5, 12, 15, 17.5, 20 or 25 vol %. The unclassified fly ash may have an average particle density of from 1.40-1.99 g/cm³, or of from 1.50-1.80 g/cm³, or of from 1.60-1.95 g/cm³, or of from 1.80-1.99 g/cm³, or of about 1.6 g/cm³ or 1.9 g/cm³. Commercial sources of unclassified fly ash will be known to those of skill in the art. A non-limiting example of a suitable unclassified ash is available from Tarong Power Station in QLD, Australia and marketed as Run-of station (ROS) ash, but other unclassified ash such as Milmerran ROS Ash are also suitable.

The unclassified ash used in the cementitious compositions and concretes cured therefrom as described herein may have any suitable PSD, but by way of non-limiting example only, a suitable PSD (calculated using a Mastersizer® with a dispersant) is shown in Table 4:

TABLE 4
Example of suitable unclassified fly ash particle size distribution
(Mastersizer ® with dispersant)

| Particle size | Example | vol % in one |
|---|---|---|
| (mm) | vol % range | suitable embodiment |
| >0.30-0.60 | 0.0 | 0.0 |
| 0.15-0.30 | 5.0-10.0 | 7.7 |
| 0.075-0.15 | 14.0-20.0 | 16.7 |
| <0.075 | 70.0-80.0 | 75.6 |

Unclassified coal fly ash generally comprises particles having subround shape and high sphericity (see Table 1). It will be understood that, although unclassified ash comprises fine particles <75 μm that might be categorised on their own as a cementitious binder (in the same way as classified coal fly ash), for the purposes of the disclosure herein, unclassified fly ash as a whole will be referred to as a lightweight aggregate. Accordingly, all calculations herein have been made on the basis of unclassified fly ash being part of the aggregate component of the solid component.

In some embodiments, the lightweight aggregate comprises coal bottom ash and/or unclassified fly ash. In one embodiment, the lightweight mineral aggregate comprises unclassified coal fly ash and coal bottom ash. Coal bottom ash and unclassified fly ash, and in particular a combination of the two, are particularly useful in the present invention for lowering concrete density (due to their relatively lower density than other non-lightweight aggregate materials such as sand and rock dust) and for their natural particle size distributions, which facilitate the solid component in reaching the 15-30 vol % of dispersed fines as well as having a particle size distribution and shape that assists in reducing particle packing such that the cementitious composition forms a cured lightweight concrete having a 28 day ambient density of at least 20% lower than an average particle density of the solid component. Without wishing to be bound by theory, the pozzolanic behaviour of coal ash particles of size <0.075 mm may also contribute to the strength of the lightweight concretes produced from the compositions herein having from 15-30 vol % of dispersible fines.

In one embodiment, the coal bottom ash used herein is wet with water prior to inclusion in the cementitious compositions. Coal bottom ash has a high absorption capacity for water and thus wetting the coal bottom ash with water prior to incorporation in the cementitious compositions described herein advantageously reduces the extent to which the ash draws water from the composition, which would otherwise be needed to adjust the flow properties of the mix and/or ensure hydraulic reactions in the cementitious composition can proceed. In one embodiment, when present in the cementitious compositions and concretes cured therefrom as described herein, coal bottom ash is saturated surface dry when used in the cementitious compositions described herein. In one embodiment, the coal bottom ash used in the cementitious compositions and concretes cured therefrom as described herein comprises from 15-25 wt % water, or from 15-20 wt %, or from 20-25 wt %, or from 17-22 wt %, or from 18-21 wt %, or about 15, 16, 17, 18, 19, 19.8, 20, 21, 22, 23, 24 or 25 wt % water.

Other lightweight aggregate may be included in the compositions described herein. Suitable lightweight aggregate materials include expanded perlite, expanded clay, expanded glass expanded vermiculite, biomass (including wood chip), scoria or a mixture of any two or more of these materials. Commercial sources of expanded perlite, expanded clay, expanded glass, expanded vermiculite, biomass (including woodchip) and scoria will be known to those of skill in the art. Non-limiting examples of suitable commercial sources of lightweight aggregate materials include Aerolite Scoria, AusPerl Perlite, and Premium Perlite and Premium Vermiculite from Exfoliators Australia. These lightweight aggregate materials may be present in the solid component at any suitable concentration, but in some embodiments, in a concentration of from 5 to 25 vol %, or of from 5 to 15 vol %, or from 9 to 13 vol %, or from 10 to 20 vol %, or from 15 to 25 vol %, or from 8 to 14 vol %, or 5, 7.5, 10, 11.5, 12, 15, 17.5, 20 or 25 vol %. The lightweight aggregate may have an average particle density of from 0.02-1.99 g/cm³, or of from 0.03-0.15 g/cm³, or of from 0.8-1.1 g/cm³, or of from 0.4-1.3 g/cm³.

The cementitious compositions described herein also comprise a non-lightweight aggregate. The cementitious compositions herein may contain any suitable amount of non-lightweight aggregate. In some embodiments, the non-lightweight aggregate is present in the solid component of the cementitious compositions and concretes cured therefrom described herein in an amount of from 35 to 80 vol %, or of from 35 to 55 vol %, or from 40 to 55 vol %, or from 45 to 55 vol %, or from 50 to 65 vol %, or from 50 to 70 vol %, or from 50 to 80 vol %, or 40, 45, 50, 55, 60, 65, 70, 75 or 80 vol %. In one embodiment, the non-lightweight aggregate is selected from a sand and a crushed rock, or a mixture thereof. In another embodiment, the non-lightweight aggregate is selected from a natural sand, a manufactured sand, and a crushed rock, or a mixture thereof. In one embodiment, the natural sand, manufactured sand, and crushed rock or mixture thereof is present in the solid component in an amount of from 40 to 65 vol %, or of from 40 to 55 vol %, or from 40 to 50 vol %, or from 45 to 55 vol %, or from 50 to 65 vol %, or from 50 to 60 vol %.

In some embodiments, the non-lightweight aggregate comprises a sand. The sand may be a natural sand, meaning that the sand is naturally formed in seabeds, coastlines, quarries and/or rivers. In other embodiments, the sand may be manufactured sand, being a sand produced from quarry dust or crushed stone and altered using machinery to produce a grading similar to natural sand. Manufactured sand is generally washed and free from silt and clay, but in some embodiments, the manufactured sand as used herein may be in unwashed form. In some embodiments, a mixture of natural and manufactured sand may be used. The total amount of sand (natural and/or manufactured) in the sold component may be any suitable amount. In one embodiment, sand is present in a total amount of from 30-50 vol %, or from 30-45 vol %, or from 35-45 vol %, or from 40-50 vol %.

In one embodiment, the non-lightweight aggregate comprises natural sand. In other embodiments, the non-lightweight aggregate is natural sand. The natural sand may be present in the solid component in any suitable amount. In some embodiments, the natural sand is present in the solid component of the cementitious composition in an amount of from 15-40 vol %, or from 15-25 vol %, or from 15-35 vol %, or from 20-35 vol %, or from 20-30 vol %, or from 30-40 vol %. In some embodiments, the natural sand has an average particle density of from 2.30-2.55 g/cm³, or of from 2.30-2.45, or of from 2.35-2.50 g/cm³, or of from 2.35-2.55 g/cm³, or of about 2.40 g/cm³, or of about 2.50 g/cm³. The natural sand used in the cementitious compositions and concretes cured therefrom as described herein may have any suitable PSD, but by way of non-limiting example only, a suitable PSD (calculated using wet sieve analysis with a dispersant, and converting mass to volume using the density of each fraction) is shown in Table 5:

TABLE 5
Example of suitable natural sand particle size
distribution (wet sieve with dispersant)

| Particle size | Example | vol % in one |
|---|---|---|
| (mm) | vol % range | suitable embodiment |
| >4.75 | 0 | 0 |
| 2.36-4.75 | 5.0-10.0 | 7.2 |
| 1.18-2.36 | 12.0-18.0 | 14.9 |
| 0.60-1.18 | 20.0-26.0 | 23.0 |
| 0.30-0.60 | 31.0-39.0 | 34.6 |
| 0.15-0.30 | 9.0-14.0 | 11.3 |
| 0.075-0.15 | 0.5-2.0 | 1.1 |
| <0.075 | 5.0-10.0 | 7.9 |

Commercial sources of natural sand will be known to those of skill in the art. Non-limiting example of suitable natural sands include natural sand sourced from Clutha Creek Quarry in QLD, Australia as product marketed as CCS Coarse Sand and comprising about 68% quartz (about 40% as free quartz grains or simple composite grains, about 26% as quartz locked with fragments of quartzite, granite, vein quartz and lithic arenite, about 1% as finely microcrystalline quartz within acid volcanics, and about 1% chalcedony) and natural sand sourced from the Clarence Valley in NSW, Australia, as product marketed as Clarence Coarse Sand. In one embodiment, the natural sand used in the cementitious compositions and concretes cured therefrom as described herein comprises from 5-20 wt % water as moisture, or from 5-10 wt %, or from 10-20 wt %, or from 15-20 wt %, or from 8-13 wt %, or about 5, 6, 7, 8, 9, 10, 11, 12, 13, 14, 15, 16, 17, 18, 19 or 20 wt % water. Natural sand generally comprises particles having subround shape (see Table 1).

In another embodiment, the non-lightweight aggregate material comprises manufactured sand. In other embodiments, the non-lightweight aggregate material is manufactured sand. In some embodiments, a mixture of two or more different manufactured sands is used. The manufactured sand may comprise crushed rock or “crusher” dust, such as a crushed igneous rock including granite or trachyte or crushed sandstone rock such as greywacke. The manufactured sand may be present in the solid component of the cementitious composition in any suitable amount. In some embodiments, the manufactured sand is present in an amount of from 10-50 vol %, or from 10-30 vol %, or from 15-45 vol %, or from 30-50 vol %. In some embodiments, the manufactured sand has an average particle density of from 2.4-2.65 g/cm³, or of from 2.45-2.50, or of from 2.50-2.55 g/cm³, or of from 2.55-2.65 g/cm³, or of about 2.50 g/cm³ or of about 2.60 g/cm³. The manufactured sand used in the cementitious compositions and concretes cured therefrom as described herein may have any suitable PSD, but by way of non-limiting example only, a suitable PSD (calculated using wet sieve analysis with a dispersant, and converting mass to volume using the density of each fraction) is shown in Table 6:

TABLE 6
Example of suitable manufactured sand particle
size distribution (wet sieve with dispersant)

| | Greywacke | | Granite | |
|---|---|---|---|---|
| | | vol % in one | | vol % in one |
| Particle size | Example | suitable | Example | suitable |
| (mm) | vol % range | embodiment | vol % range | embodiment |
| 6.70-9.50 | 0.0-0.5 | 0.0 | 0.0 | 0.0 |
| 4.75-6.70 | 1.0-3.5 | 2.1 | 0.0-1.0 | 0.0 |
| 2.36-4.75 | 25.0-31.0 | 28.0 | 17.0-23.0 | 19.8 |
| 1.18-2.36 | 16.5-22.5 | 18.8 | 14.5-19.5 | 16.8 |
| 0.60-1.18 | 6.5-11.5 | 8.8 | 10.5-15.5 | 12.8 |
| 0.30-0.60 | 7.5-12.5 | 9.8 | 13.5-18.5 | 16.0 |
| 0.15-0.30 | 5.0-10.0 | 7.6 | 9.5-14.5 | 11.8 |
| 0.075-0.15 | 4.5-8.5 | 5.8 | 5.5-10.5 | 7.8 |
| <0.075 | 16.0-22.0 | 19.1 | 12.0-18.0 | 15.2 |

Commercial sources of manufactured sand will be known to those of skill in the art. Non-limiting examples of suitable manufactured sands are those sourced from Beenleigh Quarry in QLD, Australia as product marketed as Metagraywacke Dust or from Holcim Sunrock Quarry in QLD, Australia as a trachyte rock dust or from Bracalba Quarry in QLD, Australia, as a granite dust marketed as Granite crusher dust. In one embodiment, the manufactured sand used in the cementitious compositions and concretes cured therefrom as described herein comprises from 1-wt % water as moisture, or from 1-5 wt %, or from 5-10 wt %, or from 3-7 wt %, or from 4-6 wt %, or about 1, 2, 3, 4, 5, 6, 7, 8, 9 or 10 wt % water as moisture.

In another embodiment, the non-lightweight aggregate material comprises a 5 mm-7 mm aggregate. In other embodiments, the non-lightweight aggregate material is a 5 mm-7 mm aggregate. The 5-7 mm aggregate may be present in the solid component of the cementitious composition in any suitable amount. In some embodiments, the 5-7 mm aggregate is present in an amount of from 5-20 vol %, or from 5-10 vol %, or from 10-20 vol %, or from 5-15 vol %, or from 7-18 vol %. In some embodiments, the 5-7 mm aggregate has an average particle density of from 2.45-2.65 g/cm³, or of from 2.45-2.55, or of from 2.50-2.60 g/cm³, or of about 2.55 g/cm³. Commercial sources of 5-7 mm aggregate will be known to those of skill in the art. A non-limiting example of a suitable 5-7 mm aggregate is from Bracalba Quarry in Queensland, Australia, as product marketed as 7 mm aggregate granite. In one embodiment, the 5-7 mm aggregate used in the cementitious compositions and concretes cured therefrom as described herein comprises from 0-5 wt % water as moisture, or from 1-3 wt %, or from 0.5-2 wt %, or from 3-5 wt %, or from 0.5-1.5 wt %, or about 0, 0.5, 1.0, 1.5, 2.0, 2.5, 3.0, 3.5, 4.0, 4.5 or 5.0 wt % water as moisture. Aggregate materials having sizes differing from 5-7 mm may also be suitable for use in the cementitious compositions described herein. In some embodiments, up to 10 mm aggregate may be used, although persons skilled in the art will appreciate that aggregate of this size is less suitable for use in compositions intended for pressing into concrete blocks.

Other suitable non-lightweight aggregate materials will be known to those of skill in the art. Other aggregate materials, fillers and/or additives known in the art may also be included in the cementitious compositions described herein. In some embodiments, a block slip additive may be used in the compositions described herein. Any suitable block slip additive may be used. In one embodiment, the block slip additive may comprise an alkylbenzenesulfonic acid salt, an example of which is the product Vibromix® A1. Any suitable amount of a block slip additive may be used. In some embodiments, an amount of about 0.01-0.05 vol % of block slip may be included in the solid component, or about 0.035 vol %. In other embodiments, a plasticiser may be used in the compositions described herein. Any suitable plasticiser may be used. In one embodiment, the plasticiser may be MasterCast® 1102, or may be product NRG1020 from Mapei. Any suitable amount of a plasticiser may be used. In some embodiments, an amount of about 0.01-0.06 vol % of plasticiser may be included in the solid component, or about 0.025 vol %, or about 0.05 vol %. In one embodiment, the cementitious compositions described herein comprise natural sand and manufactured sand. In one embodiment, the cementitious compositions described herein comprise a lightweight aggregate material selected from coal bottom ash, unclassified coal fly ash, expanded perlite, expanded clay, expanded glass, and expanded vermiculite or a mixture thereof, in combination with a non-lightweight aggregate material selected from natural sand, manufactured sand or crushed rock or a mixture thereof. In one embodiment, the aggregate component described herein comprises coal bottom ash and/or unclassified coal fly ash and natural or manufactured sand, or crushed rock, or a mixture thereof.

In one embodiment, the aggregate component herein comprises a lightweight mineral aggregate material consisting essentially of bottom ash, unclassified coal fly ash, expanded perlite, expanded clay, expanded glass, or expanded vermiculite or a mixture thereof, and an aggregate material selected from natural sand, manufactured sand, crusher dust, 7 mm aggregate or a mixture of any two or more of these.

The cementitious compositions herein comprise water. The term “water” when generally referring to the water in the cementitious compositions described herein may be free water, or may be water encapsulated/absorbed into any one of the materials comprising the solid component, or may be a combination of free water and encapsulated/absorbed water. The amount of water is not particularly limited, as it can be adjusted depending on the nature and amount of aggregate material(s) used and the proportion of cementitious binder present. In one embodiment, the cementitious compositions described herein comprise water in a total amount of from 4-15 wt %, or of from 5-10 wt %, or of from 6-8 wt %, or of about 4, 5, 6, 7, 8, 9, 10, 11, 12, 13, 14, or 15 wt %. In some embodiments, the water comprises free water and water absorbed into or onto the lightweight aggregate, particularly coal bottom ash. In some embodiments, the water comprises water absorbed into or onto all supplied aggregate materials. In one embodiment, the cementitious compositions described herein comprise free water in an amount of from 2-8 wt %, or from 2-5 wt %, or from 4-6 wt %, or of about 2, 3, 4, 5, 6, 7, or 8 wt %.

The cementitious compositions described herein may have any suitable water:cement ratio. The water:cement ratio for a normal strength concrete is typically between 0.30:1 and 0.75:1, such as between 0.35:1 and 0.70:1.

The cementitious compositions described herein may be in the form of a dry or zero slump mix. In one embodiment, the cementitious compositions herein are in the form of a zero slump mix. Dry or zero slump mixes are understood to be mixes that measure no slump when tested according to the Australian Standard AS 1012.3.1:2014 test described in “Methods of testing concrete: Determination of properties related to the consistency of concrete-Slump test” published 27 Mar. 2014. They generally have a total (pre-cast) water content of from 2-15 wt %. In some embodiments, where the cementitious compositions described herein are in the form of a dry/zero slump mix, the amount of free water in the composition is kept at a minimum to allow cement hydration reactions to occur and to avoid loss of strength caused by higher water:cement ratios. The cementitious composition may alternatively be in the form of a wet or non-zero mix. In one embodiment, the cementitious compositions herein are in the form of a non-zero slump mix. Wet or non-zero slump mixes are understood to be mixes that measure greater than zero slump when tested according to the Australian Standard AS 1012.3.1:2014 slump test. They generally have a total (pre-cast) water content of from 5-15%.

The cementitious compositions described herein may have any suitable fill speeds and/or vibration speeds in standard block pressing machinery. Persons of skill in the art will be familiar with commercial block pressing machinery, such as sold by Columbia Machine Inc and HESS Group. In one embodiment, the cementitious compositions described herein have a fill speed of between 2000-3000 rpm or about 2500 rpm through standard block pressing machinery. In one embodiment, the cementitious compositions described herein have a vibration speed of between 2500-3000 rpm or about 2750 rpm in standard block pressing machinery. In one embodiment, cementitious compositions described herein have a cycle time through a standard block machine of 12 s or less, or of less than 12 s, or less than 11.8 s, or less than 11.6 s, or of from 12 s to 11 s, or of from 12 s to 10 s, or of 12 s, 11.9 s, 11.8 s, 11.7 s, 11.6 s, 11.5 s, 11.4 s, 11.3 s, 11.2 s, 11.1 s, or 11.0 s.

The average particle density of the solid component of the cementitious compositions described herein may be of from 2.0 and 2.4 g/cm³, or of from 2.0-2.3 g/cm³, or of from 2.1-2.3 g/cm³, or of from 2.2-2.4 g/cm³, or of 2.0, 2.1, 2.2, 2.3, or 2.4 g/cm³. The average particle density of the solid component may be calculated by multiplying the average particle density (in g/cm³) of each material in the solid component (the cementitious binder, lightweight and non-lightweight-aggregate) by the of vol % each material in the solid component, and summing over all. An example calculation is given in Table 7:

TABLE 7
Example calculation of average particle density
of one embodiment of a solid component

| | Average Particle Density | |
|---|---|---|
| Material | (g/cm³) | Vol % |
| Cement GP | 3.11 | 9.4% |
| Manufactured Sand | 2.60 | 18.7% |
| Natural Sand | 2.40 | 24.8% |
| Bottom Ash | 1.60 | 35.8% |
| Unclassified Ash | 1.90 | 11.3% |

Avg particle density of solid component = (3.11*9.4/100) + (2.60*18.7/100) + (2.40*24.8/100) + (1.60*35.8/100) + (1.90*11.3/100) 2.16 g/cm³

The cementitious compositions described herein form a cured lightweight concrete having a 28 day ambient density of at least 20% lower than an average particle density of the solid component. In some embodiments, the cured lightweight concrete 28 day ambient density is at least 20% lower, or at least 22% lower, or at least 24% lower, or at least 26% lower than an average particle density of the solid component, or the cured lightweight concrete 28 day ambient density is from 20% to 35% lower, or from 20% to 30% lower, or from 22% to 28% lower, or from 24% to 28% lower, or from 25% to 30% lower, or about 22, 24, 26, 28 or 30% lower than the average particle density of the solid component. In some embodiments, the % is calculated as: [(solid component average particle density-concrete 28 day ambient density)/(solid component average particle density)]*100. In some embodiments, the average particle density of the solid component is between 2.0 and 2.4 g/cm³, or of from 2.0-2.3 g/cm³, or of from 2.1-2.3 g/cm³, or of from 2.2-2.4 g/cm³, or of 2.0, 2.1, 2.2, 2.3, or 2.4 g/cm³. In some embodiments, the average density of a block of concrete cured from compositions described herein is from 1.50 to 1.80 g/cm³, or from 1.50 to 1.75 g/cm³, or from 1.55 to 1.70 g/cm³, or from 1.60 to 1.72 g/cm³, or from 1.60 to 1.80 g/cm³, or of about 1.60, 1.65, 1.70, 1.75, or 1.80 g/cm³.

In some embodiments, the difference between the average particle density of the solid component (in g/cm³) and the average density of a block of concrete cured from that composition (in g/cm³) is at least about 0.35 g/cm³, or at least about 0.40 g/cm³, or at least about 0.50 g/cm³, or is from about 0.35 to 0.70 g/cm³ or from about 0.45 to 0.75 g/cm³. This difference in density reflects the particle packing efficiency, and in particular, the extent to which air has been incorporated into the cured concrete. Larger differences between the average particle density and the block density indicate relatively poorer packing efficiency of particles in the concrete than smaller differences. In some embodiments, differences between of the average particle density of a given cementitious composition and the average density of a block of concrete cured from that composition of less than 0.20 g/cm³, or less than 0.15 g/cm³, or of from 0.01 to 0.15 g/cm³, such differences representing where a cured lightweight concrete has a 28 day ambient density of within 20% of the average particle density of the solid component, form concretes that are not sufficiently lightweight and therefore not within the scope of the present invention.

As described herein, the 28 day ambient density of a concrete is the density of a concrete 28 days after moulding or pressing, whereby the concrete has been initially cured by suitable means known in the art (generally steam curing at a temperature of between 4° and 100° C. for a period of about 12 hours, but sometimes ranging from 6-24 hours) and then allowed to cool and complete curing under ambient conditions. In some embodiments, ambient conditions are a temperature of from 15 to 35° C. and a humidity of 15-100%.

The cementitious compositions described are for forming a lightweight concrete on curing. In some embodiments, the lightweight concrete prepared by curing cementitious compositions according to certain embodiments described herein has a density of between 1500 and 2000 kg/m³, or between 1550 and 1700 kg/m³, or between 1650 and 1750 kg/m³, or between 1600 and 1700 kg/m³, or between 1700 and 1800 kg/m³, or between 1500 and 1850 kg/m³, or of about 1550, 1600, 1650, 1700, 1750, 1800, or 1850 kg/m³.

Concrete prepared by curing the cementitious compositions described herein may comprise any suitable amount of water. In some embodiments, controlled curing will maintain a water content in the cementitious composition as it forms concrete of between about 4-6 wt %, or between about 4.5-5.5 wt %. In some embodiments, the water content will then gradually reduce to about 2-3 wt %, or about 2.5 wt % about 10 days after controlled curing is completed, to an ultimate minimum ‘dry weight’ or ‘ambient weight’ of concrete of about 1-2 wt % water.

Described herein is a cured lightweight concrete, or block of cured lightweight concrete, comprising a solid component comprising: a cementitious binder and an aggregate component comprising a lightweight aggregate and a non-lightweight aggregate; dispersible fines of size <75 μm in an amount of from 15.0 to 30.0 vol % as measured without use of a dispersant; and coarse particles of size >2.36 mm in an amount of ≤30 vol %; and, water; wherein particles in the aggregate component of size ≥75 μm have a particle size distribution and/or shape that reduces particle packing such that the cementitious composition forms a cured lightweight concrete having a 28 day ambient density of at least 20% lower than an average particle density of the solid component.

In some embodiments, the lightweight concrete and/or block of cured lightweight concrete may have a strength:weight ratio of from 1.5 to 2.0, or of from 1.6 to 1.8, or of from 1.6 to 2.0, or of about 1.5, 1.6, 1.65, 1.7, 1.75, 1.8, 1.9 or 2.0 at 28 days. In some embodiments, the strength:weight ratio of the block of cured lightweight concrete may be greater than 1.5, or greater than 1.6, or greater than 1.7 at 28 days. This strength:weight ratio may be measured as the 28-day compressive strength in MPa divided by the total weight of the block in kg. The lightweight concrete or block of cured lightweight concrete may have a strength:cement ratio of from 1.5 to 2.2, or of from 1.5 to 2.0, or of from 1.7 to 2.0, or of from 1.6 to 1.8, or of from 1.7 to 2.2, or of about 1.5, 1.6, 1.7, 1.8, 1.9, 2.0, 2.0 or 2.2 at 28 days. In some embodiments, the strength:cement ratio of the block of cured lightweight concrete may be greater than 1.6, or greater than 1.7, or greater than 2.0 at 28 days. This strength:cement ratio may be measured as the 28-day compressive strength in MPa divided by the percentage by volume of cement in the cementitious composition used to prepare the concrete block. Unless otherwise specified, all 28-day compressive strengths referred to in this paragraph refer to the 28-day strength under ambient curing conditions. In one embodiment, this strength is for a concrete 28 days after moulding or pressing, whereby the concrete has been initially cured by suitable means known in the art (generally steam curing at a temperature of between 4° and 100° C. for a period of about 12 hours, but sometimes ranging from 6-24 hours) and then allowed to cool and complete curing under ambient conditions of temperature of from 15 to 35° C. and a humidity of 15-100%. In one embodiment, the compressive strengths referred to herein are measured according to AS/NZS 4456.4-2003 Masonry units and segmental pavers and flags—Methods of test—Determining compressive strength of masonry units published in 2003. In one embodiment, the compressive strengths referred to herein are average compressive strengths. It will be understood that all compressive strengths referred to herein refer to the compressive strength of a standard masonry unit or “block”.

In one embodiment, lightweight concrete and/or blocks of cured lightweight concrete prepared from the cementitious compositions described herein comprise from 3-5 wt %.

In one embodiment, lightweight concrete and/or blocks of cured lightweight concrete prepared from the cementitious compositions described herein have a 28-day compressive strength of from 10 to 35 MPa, or of from 10-15 MPa, or of from 15-20 MPa, or of from 20-25 MPa, or of from 18-22 MPa, of from 20-30 MPa, or of at least 15, or of at least 16, 17, 18, 19, 20, 21, 22, 23, 24 or at least 25 MPa, or of 15, 16, 17, 18, 19, 20, 21, 22, 23, 24 or 25 MPa.

Blocks of lightweight concrete prepared from the cementitious compositions described herein may have any suitable shape. In one embodiment, the blocks have a three-dimensional shape. The three-dimensional shape may take any suitable form, including being in the form of a concrete block, such as in the form of a standard concrete masonry unit. In one embodiment, the three-dimensional shape is an H-block, which is a doubly open-ended block having a profile shape of the letter “H”. Other suitable masonry units or blocks such as A-blocks, single or double corner units, stretch units, all-purpose units, sash units, bond beam units, etc will be known to those of skill in the art and may be suitably cast from the cementitious compositions described herein. In one embodiment, the block is an H-block having dimensions of 340 mm×190 mm×190 mm. In other embodiments, the block may be a corner block having dimensions of 540 mm×140 mm×140 mm. In other embodiments, the block may be a stretcher block having dimensions of 590 mm×140 mm×140 mm. In other embodiments, the block may be a corner block or a stretcher block having dimensions of 590 mm×190 mm×190 mm. In one embodiment, a 20.48 standard masonry block comprising a concrete cured from a cementitious composition as described herein has a total mass of from 10.0-13 kg, or from 10.0-12.0 kg, or from 10.0 to 11.0 kg, or from 10.7-11.7 kg and a compressive strength of at least 15 MPa, or of at least 17 MPa, or of from 10 to 35 MPa, or of from 15 to 35 MPa, or of from 20-30 MPa, or of from 17-22 MPa. In one embodiment, a 20.48 block has a total mass of from 10.5-12.0 kg and a compressive strength of from 17 to 35 MPa.

Also described herein is a method of preparing cured lightweight concrete, comprising preparing a cementitious composition as described herein and curing the cementitious composition. Also described herein is a method of preparing a cured concrete lightweight concrete block, comprising pressing a cementitious composition as described herein into a block mould; and curing the cementitious composition. Curing conditions suitable for curing lightweight concrete will be well known to those of skill in the art and are not particularly limited in the present disclosure. In one embodiment, the lightweight concrete or block of lightweight concrete is steam cured. In such embodiments, the cementitious composition is exposed to air heated steam for a certain period of time to effect curing. In one embodiment, curing comprises exposing the composition to water vapour at a temperature of between 4° and 100° C. for a period of time of from 6 to 24 hours, generally about 12-16 hours. In another embodiment, the curing comprises exposing the composition to water vapour at a temperature of between 4° and 65° C. for a period of time of from 6 to 24 hours, or generally about 12-16 hours.

Methods of pressing concrete blocks will also be known to those of skill in the art and may include the following steps:
1. Before start of production, sand and bottom ash samples are obtained for moisture content determination. The target mix moisture is then set based on these material moisture contents.
2. Cement, ash and aggregates are weighed up.
3. Dry components are mixed for about 10 s.
4. Mixing continues until target mix moisture is reached consistently through the mix, typically 120 s, but can be up to 180-240 s.
5. Mix is dropped into the feed drawer, which rakes the material into the moulds.
6. Mix gets compressed in the moulds and then released onto plates.
7. Plates are conveyed into racks for steam curing (usually minimum of 12-16 hours) before recovery

### Preferred Embodiments/Examples

### (1) Mix Preparation

For Mixes 1-4, each of the components in Table 8 was combined in a mixing vat and water was added to a total amount of approximately 7 g/100 g entire solids mix; 7 wt % or 14 vol % to produce a slurry. A mixing time of about 120 s, or until the moisture probe in the mix detected consistent target moisture, was used for batches of between 1,500-3,200 kg.

Cement was sourced from Southern Cross Cement as product marketed as GP Cement or from ICL as product marketed as High early strength cement. Unclassified ash was sourced from Tarong Power Station, Southern Queensland, Australia as product marketed as Run-of-station ash. Coal Bottom Ash was sourced from Tarong Power Station, Southern Queensland, Australia and which burns black thermal coal from the nearby Meandu Mine, as product marketed as Bottom ash. The coal bottom ash was saturated surface dry prior to use in the composition, and as used, had a moisture content of about 20 wt %, such as about 19.8 wt %. 7 mm Aggregate was sourced from Bracalba Quarry in Queensland, Australia, as product marketed as 7 mm aggregate granite. Manufactured Sand for Mixes 1 and 2 was sourced from Holcim Sunrock Quarry in Queensland, Australia as product marketed as Metagraywacke Dust. Manufactured sand-Bracalba Granite Crusher Dust was sourced from Bracalba Quarry in Queensland, Australia, as granite crusher dust.

Natural Sand—Clutha Creek was sourced from Clutha Creek Sands Quarry in Queensland, Australia as product marketed as CCS Coarse Sand. The Natural Sand-Clutha Creek comprises about 68% quartz (about 40% as free quartz grains or simple composite grains, about 26% as quartz locked with fragments of quartzite, granite, vein quartz and lithic arenite, about 1% as finely microcrystalline quartz within acid volcanics, and about 1% chalcedony).

TABLE 8
Cementitious compositions of Mixes 1-4 and two comparative lightweight
(LW) compositions (solids in % by volume measured using a dispersant)

| | | | | | Comp. | Comp. |
|---|---|---|---|---|---|---|
| | Mix 1 | Mix 2 | Mix 3 | Mix 4 | LW Mix 1 | LW Mix 2 |
| Component | (vol %) | (vol %) | (vol %) | (vol %) | (vol %) | (vol %) |
| Cement | 9.4 | 11.5 | 10.4 | 11.2 | 10.0 | 10.1 |
| Unclassified ash | 11.3 | | 11.8 | | | |
| Tarong | | | | | | |
| Bottom Ash* | 35.8 | 45.1 | 27.6 | 37.5 | 35.0 | 26.2 |
| Tarong | | | | | | |
| 7 mm Aggregate - | | | 9.2 | 11.8 | 8.8 | 16.6 |
| Bracalba Granite | | | | | | |
| Manufactured Sand - Holcim | 18.7 | 18.7 | | | 46.2 | 29.9 |
| Graywacke dust | | | | | | |
| Manufactured sand - Bracalba | | | 41.0 | 39.5 | | 17.2 |
| Granite Crusher Dust | | | | | | |
| Natural Sand - Clutha Creek | 24.8 | 24.7 | | | | |
| TOTAL | 100 | 100 | 100 | 100 | 100 | 100 |

*Containing~20 wt % water

### (2) Particle Size Grading and Composition Analysis

Particle size analysis results for selected aggregate materials as measured by wet sieving and with dispersant is given in Table 9. Representative PSDs for the selected aggregates in Table 9 are shown graphically in FIG. 5.

TABLE 9
Particle size analysis results for selected aggregate materials
as measured by wet sieve with dispersant (Calgon solution)

| | vol % | | | | | | | |
|---|---|---|---|---|---|---|---|---|
| | >4.75 | 2.36-4.75 | 1.18-2.36 | 0.60-1.18 | 0.30-0.60 | 0.15-0.30 | 0.075-0.15 | <0.075 |
| Component | mm | mm | mm | mm | mm | mm | mm | mm) |
| Bottom ash | 0.9 | 3.8 | 5.4 | 5.2 | 14.5 | 30.3 | 19.1 | 20.8 |
| (Tarong) | | | | | | | | |
| Unclassified | 0.0 | 0.0 | 0.0 | 0.0 | 0.0 | 7.7 | 16.7 | 75.6 |
| ash (Tarong) | | | | | | | | |
| Manufactured | 2.1 | 28.0 | 18.8 | 8.8 | 9.8 | 7.6 | 5.8 | 19.1 |
| Sand (Holcim | | | | | | | | |
| Graywacke | | | | | | | | |
| dust) | | | | | | | | |
| Manufactured | 0.0 | 19.8 | 16.8 | 12.8 | 16.0 | 11.8 | 7.8 | 15.2 |
| sand - Brac | | | | | | | | |
| Granite | | | | | | | | |
| Crusher Dust | | | | | | | | |
| Natural Sand - | 0.0 | 7.2 | 14.9 | 23.0 | 34.6 | 11.3 | 1.1 | 7.9 |
| Clutha Creek | | | | | | | | |
| 7 mm | 28.8 | 68.0 | 1.1 | 0.2 | 0.1 | 0.1 | 0.3 | 1.4 |
| aggregate | | | | | | | | |
| Brac Granite | | | | | | | | |

Size grading curves have been prepared for Mixes 1-4. The grading data is shown in Table 10 below and in FIG. 1.

TABLE 10
Size grading curves for Mixes 1-4 including cement as measured
by laser diffraction for 0.150-0.300, 0.075-0.150 and <0.075
sizes and wet sieve analysis (>0.300 fraction)

| | |
|---|---|
| Particle size | vol % of solid component |

| (mm) | MIX 1 | MIX 2 | MIX 3 | MIX 4 |
|---|---|---|---|---|
| >6.70 | 0.0 | 0.0 | 0.0 | 0.0 |
| 4.75-6.70 | 0.7 | 0.8 | 2.9 | 3.7 |
| 2.36-4.75 | 8.4 | 8.7 | 15.4 | 17.3 |
| 1.18-2.36 | 9.1 | 9.6 | 8.5 | 8.8 |
| 0.600-1.18 | 9.2 | 9.7 | 6.7 | 7.0 |
| 0.300-0.600 | 15.6 | 16.9 | 10.6 | 11.8 |
| 0.150-0.300 | 16.0 | 17.9 | 14.1 | 16.0 |
| 0.075-0.150 | 10.1 | 10.0 | 10.5 | 10.3 |
| <0.075 | 31.0 | 26.4 | 31.5 | 25.1 |

As shown in FIG. 1, the PSD for Mixes 1 and 2 has a broad, flat peak in the particle size range of 0.150-0.600 mm and a second, broader peak in the size range 0.600-4.75 mm. Mixes 3 and 4 have a moderately sharp, narrow peak in size range 2.36-4.75 mm and another smaller, slightly broader peak in the range 0.15-0.30 mm.

Selected properties of Mixes 1-4 are shown in Table 11 with data for some comparative compositions.

TABLE 11
Selected properties of Mixes 1-4 and comparative (prior art) lightweight mixes

| | Avg | | Dispersible | Cement | | | 28-day |
|---|---|---|---|---|---|---|---|
| | particle | Concrete | particles <75 | in solid | Agg. | Particles >2.36 | comp |
| | density | density | μm | comp | particle | mm | strength |
| Mix | (g/cm³) | (g/cm³)# | (vol %) | (vol %) | shape | (vol %) | (MPa) |
| Mix 1 | 2.16 | 1.64 | 22.1 | 9.4 | Sub- | 18.2 | 19.2 |
| | | | | | Round | | |
| Mix 2 | 2.16 | 1.61 | 16.2 | 11.5 | Sub- | 19.1 | 18.0 |
| | | | | | Round | | |
| Mix 3 | 2.27 | 1.65 | 24.9 | 10.4 | Sub- | 18.3 | 18.0 |
| | | | | | Angular | | |
| Mix 4 | 2.26 | 1.68 | 17.1 | 11.2 | Sub- | 21.0 | 18.0 |
| | | | | | Angular | | |
| Comparative | 2.30 | 1.90 | 16.3 | 10.0 | Sub- | 24.0 | 20.0 |
| LW Mix 1 | | | | | Angular | | |
| (early Mix 1-2) | | | | | | | |
| Comparative | 2.37 | 1.76 | 16.4 | 10.1 | Sub- | 31.4 | 18.2 |
| LW Mix 2 | | | | | Angular | | |
| (early Mix 3-4) | | | | | | | |
| Comparative | — | — | est. 40-45\hat{ } | — | Sub- | — | >15.0 |
| LW Mix 3 | | | | | Round | | |
| (competitor) | | | | | | | |

\hat{ }Est. = estimated
#28-day ambient concrete density

Based on the composition data in Table 8, the particle shape data in Table 2, the density data in Table 11, and the PSDs in FIG. 1, Mixes 1 and 2 achieve a concrete having a 28 day ambient density (1.64 and 1.61 g/cm³), respectively) of at least 20% lower (24.1% and 25.4% lower, respectively) than an average particle density of the solid component (2.16 g/cm³). This is achieved with an aggregate component having, in the case of Mix 1, about 70% by volume subround particles having high sphericity vs 21% by volume subangular particles with low sphericity, and in the case of Mix 2, 79% by volume subround particles with high sphericity vs 21% by volume subangular particles with low sphericity. Accordingly, the particle roundness and sphericity compensates for the increased variation in particle size that would otherwise be expected to increase particle packing density.

On the basis of the same data, Mixes 3 and 4 achieve a concrete having a 28 day ambient density (1.65 and 1.68 g/cm³), respectively) of at least 20% lower (27.3% and 25.6% lower, respectively) than an average particle density of the solid component (2.27 and 2.26 g/cm³, respectively). This is achieved with an aggregate component having, in the case of Mix 3, about 44% by volume subround particles having medium-high sphericity vs 46% by volume subangular particles having low sphericity, and in the case of Mix 4, 45% by volume subround particles having high sphericity vs 56% by volume subangular particles having low sphericity. Accordingly, the decreased variation in particle size compensates for the increased proportions of subangular and low sphericity particles that would otherwise be expected to increase particle packing density.

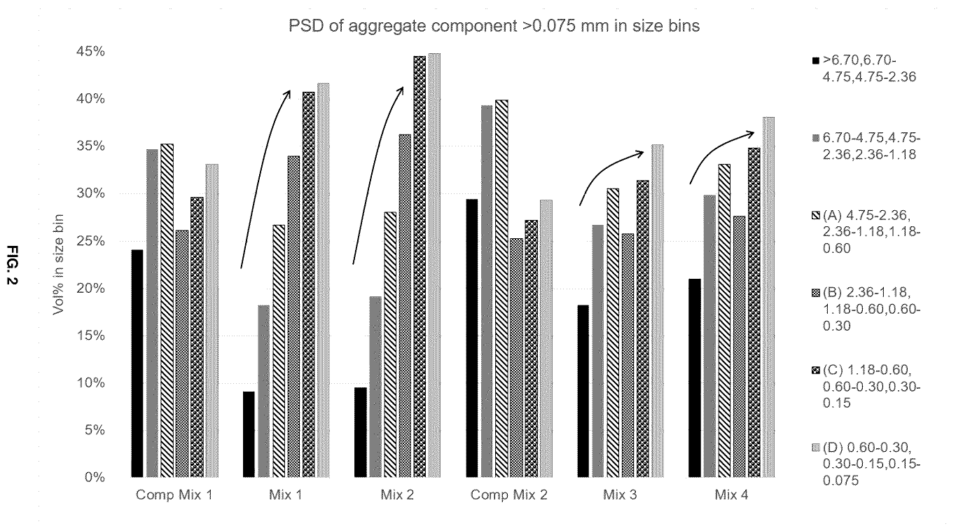

Referring to FIG. 2, PSDs for compositions are visualized in a different manner to FIG. 1, reflecting distribution of particles in Mixes 1-4 and Comparative LW Mixes 1-2 in specified size bins that each span three particle size sub-ranges. FIG. 2 demonstrates the difference between Comparative LW Mix 1 and Mixes 1 and 2 in terms of shifting to generally smaller aggregate size.

Mixes 1-4 all contain 15-30 vol % of particles having particle sizes <75 μm, $30 vol % particles having particle sizes >2.36 mm and produce a cured lightweight concrete having a 28 day ambient density of at least 20% lower than an average particle density of the solid component. Mixes 1 and 3 in particular have superior flow properties, lower cement requirements, and produce blocks having compressive strengths comparable to standard concretes and are suitable for use in civil construction applications.

In Comparative LW Mix 3, the fraction of dispersible particles <75 μm is estimated to be between 40-45 vol %, which gives rise to a tacky and soft mix that is difficult to process using standard block pressing machinery.

### (3) Concrete Block Pressing

Solid concrete blocks were prepared by pressing the mixes prepared in step (1) above. The mixes were transferred into a hopper, dropped onto a feed drawer, and raked into standard H-block moulds having dimensions 390 mm×190 mm×190 mm, which were subsequently levelled and compressed by a combination of vibration and mechanical pressing. The blocks were then steam cured at a temperature of 40-65° C. Selected flow information for Mixes 1-4 and some comparative lightweight mixes is given in Table 12 below.

TABLE 12
Selected flow information for Mixes
1-4 and comparative lightweight mixes

| | Fill | Vibration | Cycle | Cycle time |
|---|---|---|---|---|
| Concrete | speed | speed | time* | reduction |
| mix base | (rpm) | (rpm) | (s) | (s) |
| Mix 1 | 2500 | 2750 | 11.6 | −1 |
| Mix 2 | 2500 | 2750 | 12.0 | −1 |
| Mix 3 | 2500 | 2750 | 11.3 | −1 |
| Mix 4 | 2500 | 2750 | 12.0 | −1 |
| Comp LW Mix 1 | — | — | 12.0 | — |
| Comp LW Mix 2 | — | — | 12.0 | — |
| Comp LW Mix 3 | — | — | est. >12.0\hat{ } | — |

*through standard block machine
\hat{ }Est. = estimated

The compressive strength, block weight and block slip were measured experimentally for concrete blocks pressed from each of Mixes 1-4 (see Table 13 below).

TABLE 13
Properties of concrete blocks manufactured using cementitious compositions
described herein and two comparative lightweight mixes

| | | Avg block | Compressive Strength | | Strength: | Strength: |
|---|---|---|---|---|---|---|
| Concrete | Block slip | weight | (MPa) | | weight | cement |
| mix base | (mL)* | (kg) | 3 Day | 28 Day | ratio\hat{ } | ratio\hat{ } |
| Mix 1 | 365 | 11.0 | 15.5 | 19.2 | 1.75 | 2.03 |
| Mix 2 | 365 | 10.9 | 12.0 | 18.0 | 1.65 | 1.57 |
| Mix 3 | 275 | 11.0 | 12.9 | 18.0 | 1.64 | 1.73 |
| Mix 4 | 275 | 11.2 | 14.5 | 18.0 | 1.61 | 1.61 |
| Comp LW | — | 12.4 | 13.5 | 20.0 | 1.61 | 1.99 |
| Mix 1 | | | | | | |
| Comp LW | — | 12.0 | 14.1 | 18.2 | 1.52 | 1.80 |
| Mix 2 | | | | | | |

*with Vibromix A1 per tonne total mix
**Based on 20.28 H-block dimensions 390 mm × 190 mm × 190 mm
\hat{ }strength is compressive strength in MPa at 28 days; cement is vol %; weight is in kg.

Based on the data in Tables 12 and 13, mix performance for Mixes 1-4 both for flow into and through the block machine and also the strengths that can be achieved (in particular, the greatest strength at a given block weight with the minimum cement requirement) is excellent when the mix comprises from 15 vol % to 30 vol % of dispersible fines, ≤30 vol % of particles >2.36 mm, and cure to form lightweight concretes having a 28 day ambient density of at least 20% lower than an average particle density of the solid component. The increase in strength relative to a typical mix having less than 15 vol % dispersible fines is in the range of 30%-50% higher (data not shown).

As per Table 12, the compositions described herein comprising from 15 vol % to 30 vol % of dispersible fines, ≤30 vol % of particles >2.36 mm, and that cure to lightweight concretes having a 28 day ambient density of at least 20% lower than an average particle density of the solid component are particularly advantageous compositions both in terms of flow and strength, as the particle size distribution across fines, coarse particles and across all sizes >0.075 mm, particle shape and the presence of lightweight aggregate advantageously lightens the mix at the same time as significantly contributing to particle packing critical for achieving high strengths. The compositions described herein can thus produce 390 mm×190 mm×190 mm concrete H-blocks having a mass of between 10.5 kg and 11.5 kg (i.e., in the lightweight mass range) but equivalent strength to a standard weight concrete H-block having a mass of 12.0 kg-12.5 kg.

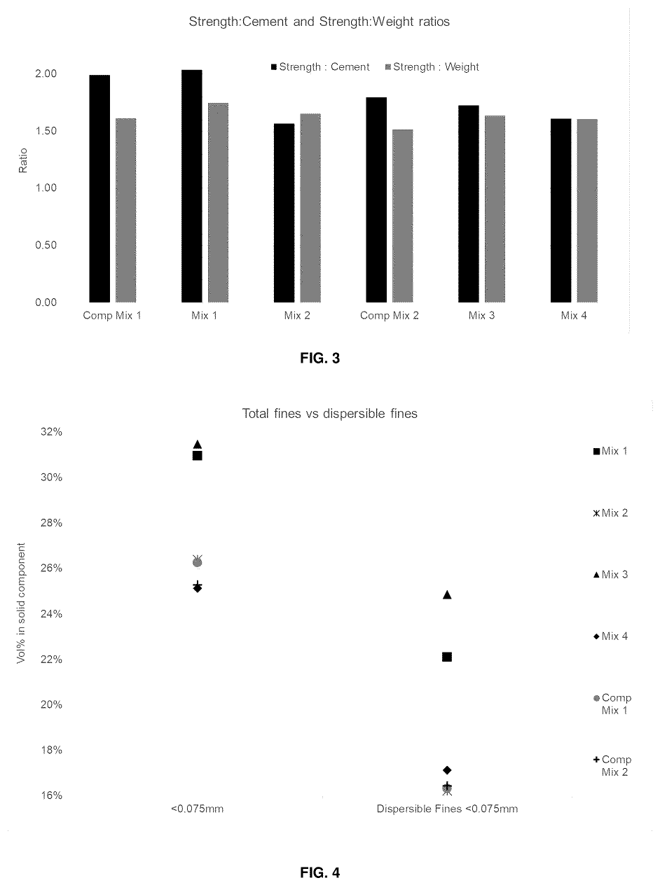

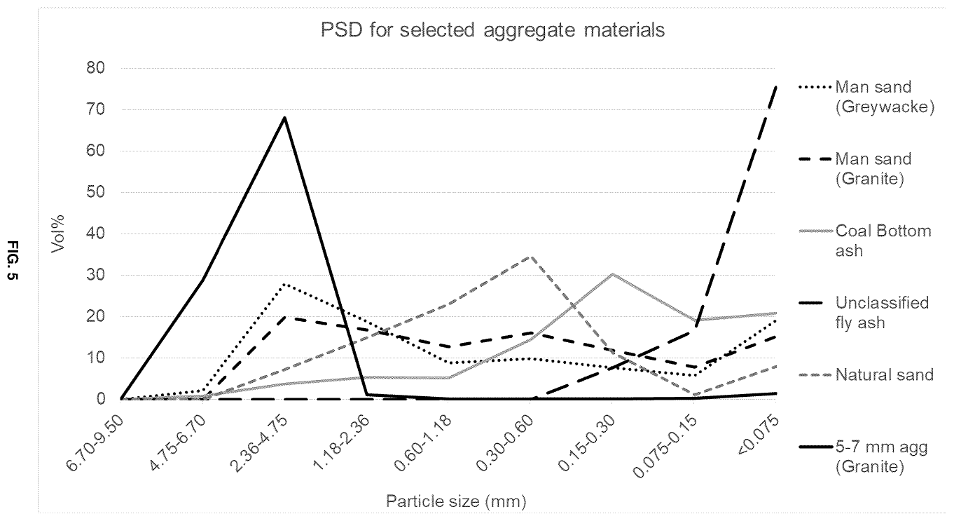

Referring to FIG. 3, the strength:weight and strength:cement ratios calculated experimentally for lightweight concrete mixes 1-4 formed from cementitious compositions according to certain embodiments of the present invention are shown (based on the data in Table 13) compared to the same ratios for two comparative LW mixes. Table 13 data also indicates early strength as measured at 3 days for lightweight mixes 1-4 and comparative LW mixes. FIG. 4 shows the difference in particle size distribution in the dispersed fines <0.075 mm vs the total fines <0.075 mm in Mixes 1-4 and two comparative compositions. Based on FIGS. 3 and 4, Mix 1 has the highest strength:weight and strength:cement ratio of the tested samples at 28 days and is equivalent to a ˜30-40% increase in performance of the cement in the mix compared to a typical denseweight block comprising an equal vol % of cement. Mix 1 also produces a light block. Mix 3 also has a high strength:cement ratio and produced a light block. As cement is the most expensive component of the mixes and significantly contributes to the commercial viability of a concrete mix, the compositions described in certain embodiments herein are particularly advantageous for commercial scale up. An increased proportion of dispersed fines <0.075 mm in Mixes 1-4 compared to Comparative LW Mixes 1-2 demonstrably gave Mixes 1-4 a strength advantage, particularly evident in the strength:weight ratios where incorporation of unclassified coal ash in Mixes 1 and 3 both lightened (in the >0.075 mm fraction) and strengthened (in the <0.075 mm fraction) the mix. The 3-day compressive strength data in Table 13 also demonstrates that the strength gains in the compositions herein are not from pozzolanic reactions with the unclassified fly ash alone, but rather are associated with the dispersible fines in the compositions producing a denser cement matrix.

The present invention is described with reference to the above examples. It is to be understood that the examples are illustrative of and not limiting to the invention described herein.

### Embodiment Paragraphs

Paragraph 1. A cementitious composition for forming a lightweight concrete on curing, comprising:
   a solid component comprising:
   a cementitious binder and an aggregate component comprising a lightweight aggregate and a non-lightweight aggregate;
   dispersible fines of size <75 μm in an amount of from 15.0 to 30.0 vol % as measured without use of a dispersant; and
   coarse particles of size >2.36 mm in an amount of ≤30 vol %;
and, water;
   wherein particles in the aggregate component of size ≥75 μm have a particle size distribution and/or shape that reduces particle packing such that the cementitious composition forms a cured lightweight concrete having a 28 day ambient density of at least 20% lower than an average particle density of the solid component.
Paragraph 2. The cementitious composition of Paragraph 1, wherein the cementitious composition forms a cured lightweight concrete block having a 28 day compressive strength of from 15 to 35 MPa.
Paragraph 3. The cementitious composition of Paragraph 1 or Paragraph 2, wherein the cementitious composition forms a cured lightweight concrete having a density of from 1600 to 1800 kg/m³, such as from 1650 to 1750 kg/m³.
Paragraph 4. The cementitious composition of any one of the preceding Paragraphs, wherein size is a maximum volume equivalent sphere diameter.
Paragraph 5. The cementitious composition of any one of the preceding Paragraphs, wherein size and particle size distribution is measured by laser diffraction and/or wet sieve analysis, optionally with use of a dispersant.
Paragraph 6. The cementitious composition of any one of the preceding Paragraphs, wherein the solid component comprises dispersible fines of size <75 μm in an amount of from 20.0 to 30.0 vol % as measured without use of a dispersant, such as from 22.0 to 30.0 vol %.
Paragraph 7. The cementitious composition of any one of the preceding Paragraphs, wherein the solid component comprises coarse particles of size >2.36 mm in an amount of ≤25 vol %, such as from 15 to 25 vol %.
Paragraph 8. The cementitious composition of any one of the preceding Paragraphs, wherein the particle size distribution of particles in the solid component of size ≥75 μm is measured with use of a dispersant, such as a medium chain polyphosphate.
Paragraph 9. The cementitious composition of any one of the preceding Paragraphs, wherein the shape is roundness and/or sphericity.
Paragraph 10. The cementitious composition of any one of the preceding Paragraphs, wherein the particle size distribution comprises at least 25 vol % of particles of size ≥75 μm in each of at least three size bins selected from (A) 4.75-2.36 mm, 1.18-2.36 mm and 0.600-1.18 mm (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm.
Paragraph 11. The cementitious composition of any one of the preceding Paragraphs, wherein the aggregate component comprises at least 50 vol %, optionally at least 60 vol %, further optionally at least 70 vol %, particles having a subround shape and/or high sphericity.
Paragraph 12. The cementitious composition of any one of the preceding Paragraphs, wherein the shape is roundness of >0.5, and optionally also a sphericity of >0.5, and wherein the particle size distribution comprises at least 25 vol % of particles of size ≥75 μm in each of at least three size bins selected from (A) 4.75-2.36 mm, 1.18-2.36 mm and 0.600-1.18 mm (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm.
Paragraph 13. The cementitious composition of any one of Paragraphs 1 to 9, wherein the particle size distribution comprises at least 35 vol % of particles of size ≥75 μm in each of at least two consecutive size bins selected from, in order, (A) 4.75-2.36 mm, 1.18-2.36 mm and 0.600-1.18 mm, (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm.
Paragraph 14. The cementitious composition of any one of Paragraphs 1 to 9 or 13, wherein the aggregate component comprises at least 30 vol %, optionally at least 40 vol %, further optionally at least 50 vol %, particles having a subangular shape and/or low sphericity.
Paragraph 15. The cementitious composition of any one of Paragraphs 1 to 9 or 13 to 14, wherein the shape is roundness of <0.5, and optionally also a sphericity of <0.5, and wherein the particle size distribution comprises at least 35 vol % of particles of size ≥75 μm in each of at least two consecutive size bins selected from, in order, (A) 4.75-2.36 mm, 1.18-2.36 mm and 0.600-1.18 mm, (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm.
Paragraph 16. The cementitious composition of any one of the preceding Paragraphs, wherein the 28 day ambient density is from 20% to 35% lower than the average particle density of the solid component.
Paragraph 17. The cementitious composition of any one of the preceding Paragraphs, wherein the lightweight aggregate has an average particle density of from 0.01 to 2.0 g/cm³.
Paragraph 18. The cementitious composition of any one of the preceding Paragraphs, wherein the lightweight aggregate is selected from: coal ash, including unclassified coal ash and coal bottom ash, other bottom ash, including biomass bottom ash, expanded perlite, expanded clay, expanded glass, expanded vermiculite, scoria, and biomass, including woodchip.
Paragraph 19. The cementitious composition of any one of the preceding Paragraphs, wherein the lightweight aggregate is present in the solid component in an amount of from 10 vol % to 55 vol %, such as from 30 to 50 vol %.
Paragraph 20. The cementitious composition of any one of the preceding Paragraphs, wherein the lightweight aggregate is a lightweight mineral aggregate.
Paragraph 21. The cementitious composition of any one of the preceding Paragraphs, wherein the lightweight aggregate is selected from coal bottom ash, unclassified coal ash, or a mixture thereof, optionally wherein the coal bottom ash is saturated surface dry.
Paragraph 22. The cementitious composition of any one of the preceding Paragraphs, wherein the non-lightweight aggregate has an average particle density of from 2.30-2.65 g/cm³.
Paragraph 23. The cementitious composition of any one of the preceding Paragraphs, wherein the non-lightweight aggregate is selected from a natural sand, a manufactured sand, and a crushed rock, or a mixture thereof.
Paragraph 24. The cementitious composition of any one of the preceding Paragraphs, wherein the non-lightweight aggregate is present in the solid component in an amount of from 35 to 80 vol %, such as from 40 to 55 vol %.
Paragraph 25. The cementitious composition of any one of the preceding Paragraphs, wherein the solid component comprises from 5-15 vol % of cementitious binder, optionally from 8 to 12 vol % cementitious binder, optionally wherein the cementitious binder is Portland cement.
Paragraph 26. The cementitious composition of any one of the preceding Paragraphs, wherein the cementitious binder forms 35-75% by volume of the dispersible fines.
Paragraph 27. The cementitious composition of any one of the preceding Paragraphs, wherein the composition comprises from 2-8 wt % free water, optionally from 4-6 wt % free water. Paragraph 28. The cementitious composition of any one of the preceding Paragraphs, wherein the 28 day ambient density is measured after from 6 to 24 hrs of steam curing and subsequent exposure to temperatures of from 15 to 35° C. and from 10 to 100% humidity.
Paragraph 29. The cementitious composition of any one of the preceding Paragraphs, in the form of a dry or zero slump mix.
Paragraph 30. The cementitious composition of any one of Paragraphs 1 to 28, in the form of a wet or non-zero slump mix.
Paragraph 31. A lightweight concrete, comprising:
   a solid component comprising:
   a cementitious binder and an aggregate component comprising a lightweight aggregate and a non-lightweight aggregate;
   dispersible fines of size <75 μm in an amount of from 15.0 to 30.0 vol % as measured without use of a dispersant; and
   coarse particles of size >2.36 mm in an amount of ≤30 vol %;
and, water;
   wherein particles in the aggregate component of size ≥75 μm have a particle size distribution and/or shape that reduces particle packing such that the lightweight concrete has a 28 day ambient density of at least 20% lower than an average particle density of the solid component.
Paragraph 32. A block of cured lightweight concrete, comprising:
   a solid component comprising:
   a cementitious binder and an aggregate component comprising a lightweight aggregate and a non-lightweight aggregate;
   dispersible fines of size <75 μm in an amount of from 15.0 to 30.0 vol % as measured without use of a dispersant; and
   coarse particles of size >2.36 mm in an amount of ≤30 vol %;
and, water;
   wherein particles in the aggregate component of size ≥75 μm have a particle size distribution and/or shape that reduces particle packing such that the cured lightweight concrete has a 28 day ambient density of at least 20% lower than an average particle density of the solid component.
Paragraph 33. The concrete of Paragraph 31 or the block of Paragraph 32, wherein size is a maximum volume equivalent sphere diameter.
Paragraph 34. The concrete of Paragraph 31 or Paragraph 33 or the block of Paragraph 32 or Paragraph 33, wherein size and particle size distribution is measured by laser diffraction and/or wet sieve analysis, optionally with use of a dispersant.
Paragraph 35. The concrete of any one of Paragraphs 31 or 33 to 34 or the block of any one of Paragraphs 32 to 34, wherein the solid component comprises dispersible fines of size <75 μm in an amount of from 20.0 to 30.0 vol % as measured without use of a dispersant, such as from 22.0 to 30.0 vol %.
Paragraph 36. The concrete of any one of Paragraphs 31 or 33 to 35 or the block of any one of Paragraphs 32 to 35, wherein the solid component comprises coarse particles of size >2.36 mm in an amount of ≤20 vol %, such as from 15 to 20 vol %.
Paragraph 37. The concrete of any one of Paragraphs 31 or 33 to 36 or the block of any one of Paragraphs 32 to 36, wherein the particle size distribution of particles in the solid component of size ≥75 μm is measured with use of a dispersant, such as a medium chain polyphosphate.
Paragraph 38. The concrete of any one of Paragraphs 31 or 33 to 37 or the block of any one of Paragraphs 32 to 37, wherein the shape is roundness and/or sphericity.
Paragraph 39. The concrete of any one of Paragraphs 31 or 33 to 38 or the block of any one of Paragraphs 32 to 38, wherein the 28 day ambient density is from 20% to 35% lower than the average particle density of the solid component.
Paragraph 40. The concrete of any one of Paragraphs 31 or 33 to 39 or the block of any one of Paragraphs 32 to 39, wherein the lightweight aggregate has an average particle density of from 0.01 to 2.0 g/cm³.
Paragraph 41. The concrete of any one of Paragraphs 31 or 33 to 40 or the block of any one of Paragraphs 32 to 40, wherein the lightweight aggregate is selected from: coal ash, including unclassified coal ash and coal bottom ash, other bottom ash, including biomass bottom ash, expanded perlite, expanded clay, expanded glass, expanded vermiculite, scoria, and biomass, including woodchip.
Paragraph 42. The concrete of any one of Paragraphs 31 or 33 to 41 or the block of any one of Paragraphs 32 to 41, wherein the non-lightweight aggregate is selected from a natural sand, a manufactured sand, and a crushed rock, or a mixture thereof.
Paragraph 43. The concrete of any one of Paragraphs 31 or 33 to 42 or the block of any one of Paragraphs 32 to 42, wherein the lightweight concrete has a density of between 1600 and 1800 kg/m³, optionally between 1650 and 1750 kg/cm³.
Paragraph 44. The concrete of any one of Paragraphs 31 or 33 to 43 or the block of any one of Paragraphs 32 to 43, wherein the lightweight concrete has a water content after curing of from 3-5 wt %.
Paragraph 45. The concrete of any one of Paragraphs 31 or 33 to 44 or the block of any one of Paragraphs 32 to 44, wherein the lightweight concrete forms a block having a 28-day compressive strength of from 15 to 35 MPa, optionally of from 20-30 MPa.
Paragraph 46. The concrete of any one of Paragraphs 31 or 33 to 45 or the block of any one of Paragraphs 32 to 45, wherein the lightweight concrete forms a block having a strength:weight ratio of from 1.5 to 2.0, or of greater than 1.6, as measured as the 28-day compressive strength in MPa divided by the total weight of the block in kg.
Paragraph 47. The concrete of any one of Paragraphs 31 or 33 to 46 or the block of any one of Paragraphs 32 to 46, wherein the lightweight concrete forms a block having a strength:cement ratio of from 1.5 to 2.2, or of greater than 1.7, as measured as the 28-day compressive strength in MPa divided by the total volume of the cement in m³.
Paragraph 48. The block of any one of Paragraphs 32 to 47, wherein the block has a three-dimensional shape, optionally in the form of a three-dimensional H-block.
Paragraph 49. A method of preparing lightweight concrete, comprising:
   preparing a cementitious composition comprising:
   a solid component comprising:
   a cementitious binder and an aggregate component comprising a lightweight aggregate and a non-lightweight aggregate;
   dispersible fines of size <75 μm in an amount of from 15.0 to 30.0 vol % as measured without use of a dispersant; and
   coarse particles of size >2.36 mm in an amount of ≤30 vol %;
   and, water;
   and,
   curing the cementitious composition to form lightweight concrete;
   wherein particles in the aggregate component of size ≥75 μm have a particle size distribution and/or shape that reduces particle packing such that the lightweight concrete formed from the cementitious composition has a 28 day ambient density of at least 20% lower than an average particle density of the solid component.
Paragraph 50. A method of preparing lightweight concrete, comprising:
   preparing a cementitious composition according to any one of Paragraphs 1 to 30; and
   curing the cementitious composition to form lightweight concrete.
Paragraph 51. A method of preparing a lightweight concrete block, comprising:
   preparing a cementitious composition comprising:
   a solid component comprising:
   a cementitious binder and an aggregate component comprising a lightweight aggregate and a non-lightweight aggregate;
   dispersible fines of size <75 μm in an amount of from 15.0 to 30.0 vol % as measured without use of a dispersant; and
   coarse particles of size >2.36 mm in an amount of ≤30 vol %;
   and, water;
   pressing the cementitious composition into a mould; and
   curing the cementitious composition to form a lightweight concrete block;
   wherein particles in the aggregate component of size ≥75 μm have a particle size distribution and/or shape that reduces particle packing such that the lightweight concrete formed from the cementitious composition has a 28 day ambient density of at least 20% lower than an average particle density of the solid component.
Paragraph 52. A method of preparing a lightweight concrete block, comprising:
   preparing a cementitious composition according to any one of Paragraphs 1 to 30;
   pressing the cementitious composition into a block mould; and
   curing the cementitious composition to form lightweight concrete.
Paragraph 53. The method of any one of Paragraphs 49 to 52, wherein the curing comprises exposing the cementitious composition to air and water vapour at a temperature of between 4° and 100° C. for a period of time of from 6 to 24 hours.
Paragraph 54. A lightweight concrete prepared by curing a cementitious composition according to any one of Paragraphs 1 to 30.
Paragraph 55. The lightweight concrete of Paragraphs 54, prepared by steam curing.

1. A cementitious composition for forming a lightweight concrete on curing, comprising:
a solid component comprising:
a cementitious binder and an aggregate component comprising a lightweight aggregate and a non-lightweight aggregate;
dispersible fines of size <75 μm in an amount of from 15.0 to 30.0 vol % as measured without use of a dispersant; and
coarse particles of size >2.36 mm in an amount of ≤30 vol %;
and,
water;
wherein particles in the aggregate component of size ≥75 μm have a particle size distribution and/or shape that reduces particle packing such that the cementitious composition forms a cured lightweight concrete having a 28 day ambient density of at least 20% lower than an average particle density of the solid component.

2. The cementitious composition of claim 1, wherein the cementitious composition forms a cured lightweight concrete block having a 28 day compressive strength of from 15 to 35 MPa.

3. The cementitious composition of claim 1, wherein the cementitious composition forms a cured lightweight concrete having a density of from 1600 to 1800 kg/m³.

4. The cementitious composition of claim 1, wherein size and particle size distribution is measured by laser diffraction and/or wet sieve analysis.

5. The cementitious composition of claim 1, wherein the solid component comprises dispersible fines of size <75 μm in an amount of from 20.0 to 30.0 vol % as measured without use of a dispersant.

6. The cementitious composition of claim 1, wherein the solid component comprises coarse particles of size >2.36 mm in an amount of ≤25 vol %.

7. The cementitious composition of claim 1, wherein the particle size distribution of particles in the solid component of size ≥75 μm is measured with use of a dispersant.

8. The cementitious composition of claim 1, wherein the shape is roundness and/or sphericity.

9. The cementitious composition of claim 1, wherein the shape is roundness of >0.5, and optionally also a sphericity of >0.5, and wherein the particle size distribution comprises at least 25 vol % of particles of size ≥75 μm in each of at least three size bins selected from (A) 4.75-2.36 mm, 1.18-2.36 mm and 0.600-1.18 mm (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm.

10. The cementitious composition of claim 1, wherein the shape is roundness of <0.5, and optionally also a sphericity of <0.5, and wherein the particle size distribution comprises at least 35 vol % of particles of size ≥75 μm in each of at least two consecutive size bins selected from, in order, (A) 4.75-2.36 mm, 1.18-2.36 mm and 0.600-1.18 mm, (B) 1.18-2.36 mm, 0.600-1.18 mm and 0.300-0.600 mm, (C) 0.600-1.18 mm, 0.300-0.600 mm, and 0.150-0.300 mm, and (D) 0.300-0.600 mm, 0.150-0.300 mm, and 0.075-0.150 mm.

11. The cementitious composition of claim 1, wherein the 28 day ambient density is from 20% to 35% lower than the average particle density of the solid component.

12. The cementitious composition of claim 1, wherein the lightweight aggregate is selected from: coal ash, including unclassified coal ash and coal bottom ash, other bottom ash, including biomass bottom ash, expanded perlite, expanded clay, expanded glass, expanded vermiculite, scoria, and biomass, including woodchip.

13. The cementitious composition of claim 1, wherein the lightweight aggregate is present in the solid component in an amount of from 10 vol % to 55 vol %, such as from 30 to 50 vole.

14. (canceled)

15. The cementitious composition of claim 1, wherein the non-lightweight aggregate is present in the solid component in an amount of from 35 to 80 vol %, such as from 40 to 55 vol %.

16. The cementitious composition of claim 1, wherein the solid component comprises from 5-15 vol % of cementitious binder.

17. The cementitious composition of claim 1, wherein the cementitious binder forms 35-75% by volume of the dispersible fines.

18. The cementitious composition of claim 1, wherein the composition comprises from 2-8 wt % free water.

19. A method of preparing lightweight concrete, comprising:
preparing the cementitious composition of claim 1;
optionally pressing the cementitious composition into a block mould; and
curing the cementitious composition to form lightweight concrete.

20. (canceled)

21. The method of claim 19, wherein the curing comprises exposing the cementitious composition to air and water vapour at a temperature of between 40 and 100° C. for a period of time of from 6 to 24 hours.

22. The method of claim 19, wherein the lightweight concrete forms a block having a 28-day compressive strength of from 15 to 35 MPa or having a strength:weight ratio of from 1.5 to 2.0, or of greater than 1.6, as measured as the 28-day compressive strength in MPa divided by the total weight of the block in kg.

23. (canceled)

24. (canceled)

25. (canceled)
